(19) United States
(12) Patent Application Publication
(10) Pub. No.: US 2018/0065109 A1
(43) Pub. Date: Mar. 8, 2018

(54) MESOPOROUS MATERIALS

(71) Applicant: UNIVERSITY COURT OF THE UNIVERSITY OF ST ANDREWS, St. Andrews, Fife (GB)

(72) Inventors: Richard BAKER, St. Andrews, Fife (GB); Troy Allen DOUGHERTY, Lower Hutt (NZ)

(21) Appl. No.: 15/551,122

(22) PCT Filed: Feb. 9, 2016
(86) PCT No.: PCT/GB2016/050296

§ 371 Date: Aug. 15, 2017

(30) Foreign Application Priority Data
Feb. 19, 2015 (GB) 1502813.7

(51) Int. Cl. B01J 23/10; B01J 35/00; B01J 35/02; B01J 35/10; C01B 13/18; C01F 17/00

(52) U.S. Cl. CPC B01J 23/10; B01J 35/002; B01J 35/023; B01J 35/1085; C01B 13/18; C01F 17/0043; G01N 23/20075; C01P 2002/60; C01P 2002/72; C01P 2004/04; C01P 2006/12; C01P 2006/14; C01P 2006/17; C01P 2002/54

(57) ABSTRACT

The invention relates to the field of mesoporous materials and in particular to mesoporous rare earth oxides and a method of their synthesis.

### FIELD OF THE INVENTION

The invention relates to the field of mesoporous materials and in particular to mesoporous rare earth oxides and a method of their synthesis.

### BACKGROUND TO THE INVENTION

Rare earth oxide materials and related doped and mixed metal oxides including rare earth elements are a class of materials which have a wide range of potential applications. The rare earth elements (comprising the lanthanide series, yttrium and scandium) are capable of adopting a range of oxidation states. The transition between oxidation states is typically relatively easy to achieve. Moreover, many non-stoichiometric phases are known in which electronic and/or oxygen ion conductivity is possible. By virtue of these properties, the rare earth oxides lend themselves to applications such as redox catalysis, semiconductors, fuel cell electrodes and electrolytes and photovoltaics.

Ceria is the oxide of the most abundant of the rare earth metals, cerium. Ceria and so called doped cerias, where Ce is partly substituted by Rare Earth, transition or other metals to form complex mixed metal oxides, are of great technological and industrial interest. When partly reduced, ceria becomes an electronic conductor because of the presence of the Ce³⁺/Ce⁴⁺ couple, and may be of interest in applications such as photovoltaic cells.

Because of their ability to store and release oxygen, ceria and ZrₓCe₁₋ₓO₂, where Zr increases catalytic activity and thermal stability, are widely used in automotive three-way catalysts, as well as in other industrial redox catalysts. Cerium containing oxides are receiving very significant and increasing attention for applications in solid oxide fuel cells (SOFCs).

Allovalent doping of ceria (e.g. M³⁺ for Ce⁴⁺) results in oxygen ion vacancies and excellent oxygen ion conductivity, for example in CeₓGd₁₋ₓO_{2-x/2} and CeₓSm₁₋ₓO_{2-x/2}, which are very promising SOFC electrolyte materials. The catalysts, ZrₓCe₁₋ₓO₂, as well as CeₓGd₁₋ₓO_{2-x/2} and CeₓSm₁₋ₓO_{2-x/2}, are of interest as anode components for SOFCs running on challenging hydrocarbon fuels. These materials typically have good thermal stability. Ceria is also of low toxicity, and its low solubility means that it cannot be absorbed into the body easily.

Yttria-stabilized zirconia (YSZ) is another example of a material comprising vacancies in the oxygen lattice which allow for oxygen ion conductivity. YSZ has been well studied as a SOFC electrolyte material, as well as for porous SOFC anodes.

Another commonly investigated class of rare earth oxide materials are lanthanum-based oxides having ABO₃ perovskite-type structures, e.g. LaGaO₃ and doped analogues such as lanthanum strontium gallate (LSG) and lanthanum strontium gallium magnesium oxide (La₁₋ₓSrₓGa_{y}Mg_{1-y}O₂, LSGM), or lanthanum strontium cobaltite (La₁₋ₓSrₓCoO₃, LSC). LSGM and LSC are of interest as SOFC electrolyte and cathode materials, respectively.

Since their development in the 1990s, mesoporous materials (porous materials, having pore sizes in the range 2-50 nm diameter, and, typically, with uniform pores arranged in periodic (‘ordered’) arrays) have been of interest for filtration, optical applications, gas adsorption and storage and as supports for active phases in catalysts, such as metals, metal oxides and the rare earth oxides discussed above. Initially, such active phases were deposited on existing mesoporous materials (such as silicate, sodium silicate or carbon based mesoporous materials). It has long been recognised that this strategy has the potential to combine the high surface areas of the mesoporous materials with the catalytic properties of any finely-divided catalytically active materials deposited therein.

The first well-studied ordered mesoporous materials were the “MCMs” (Mobil Crystalline Materials) such as MCM-41 and MCM-48. MCM-41 has a 1D cylindrical pore network in a hexagonal array, whereas MCM-48 has a 3D bi-continuous pore structure in a cubic array. These materials were silicates or aluminosilicates, had a high specific surface area (>1,000 m²g⁻¹) and their regular pore network gave rise to a very high pore volume (0.79 cm³g⁻¹ for MCM-41).

Another well studied mesoporous material is the silica, SBA-15 (University of Santa Barbara Amorphous, No. 15), which has a hexagonal array of 1-D cylindrical pores/channels which are interconnected by micropores (ca. 2 nm diameter) which allow for the movement of small species between the mesopores.

KIT-6 (Korea Institute of Technology, No. 6), also a silica, has a 3D bi-continuous wormhole pore system arranged in a cubic array. FDU-12 (Fudan University, No. 12) has a face-centred cubic (FCC) 3D cage pore system in which large cavities (typically 10-12 nm diameter) are interconnected by narrower channels (typically 4-9 nm diameter).

Many further mesoporous materials are known.

It has been shown that by varying the reaction conditions (for example, by varying temperature, selection of swelling agents), silica or sodium silicate mesoporous materials of a given structure type can be made with a range of pore dimensions, wall-thicknesses, and/or pore morphologies.

More recently, mesoporous phases of metal oxide materials have been developed, with a view to combining the high surface areas of the mesoporous structures with the bulk properties of the oxides themselves (which is not provided by discrete oxide crystallites deposited on/in silicate/silica mesoporous materials, for example). However, to date the synthesis of mesoporous metal oxides, and mesoporous rare earth oxide materials in particular, has suffered from certain drawbacks.

One strategy has been to synthesise mesoporous metal oxides using sol-gel techniques, analogous to those used to prepare mesoporous silicas. This strategy involves the use of surfactants such as tertiary ammonium salts as structure directing agents in solution, so as to form oxides by “soft-templating” or “co-operative self assembly” around micelles in solution. By appropriate manipulation of the micellular solution, the pore size of the resulting mesoporous material can be tuned.

Sol-gel techniques have been utilised to produce well ordered mesoporous main group and transition metal-containing oxides, e.g. WO₃, SnO₂, HfO₂, SiTiO₄, Al₂TiO₅, ZrTiO₄, Nb₂O₅, YbO₂₋TiO₂. By “transition metal” we refer to an element whose atom has a partially filled d sub-shell, or which can give rise to cations with an incomplete d sub-shell, but not including the rare earth elements mentioned above.

A small number of rare earth metal-containing mesoporous oxides have also been produced in this way, e.g. ZrₓCe₁₋ₓO₂. Sol-gel synthesised mesoporous oxides are typically characterised by having thin (4-6 nm) pore walls, comprised of amorphous oxide phases or randomly oriented nanocrystallites. In addition, mesopore dimensions are comparatively small (5-8 nm).

So called “hard templating” or “nanocasting” methods have since been developed. Nanocasting involves taking an already formed ordered mesoporous material, typically a mesoporous silica or carbon, and using this as a mould or template for a new material. The template may then be removed. Silica templates are normally digested by either hot NaOH or HF and carbon templates by oxidation in air.

The most widely used nanocasting method involves adding a solution of a metal salt precursor (typically a nitrate) to the mesoporous template. The precursor moves into the template through capillary action and then the solvent is evaporated leaving the precursor inside the template. This method is also commonly called the incipient wetness impregnation technique (IWIT).

The material is then calcined and, during calcination it is proposed that the precursors decompose to form oxide nanoparticles, which ultimately agglomerate and in some cases align and/or crystallise to form the pore walls of mesoporous particles that can persist once the template has been digested.

The IWIT method has been successfully applied to form a range of mesoporous transition and/or rare earth metal oxides, such as Cr₂O₃, Co₃O₄, Fe₂O₃, and ceria, CeO₂. Mesoporous oxides of tungsten, manganese, zinc, zirconium, indium and main group metal oxides, e.g. of magnesium and aluminium, have also been prepared in this manner.

IWIT suffers from several drawbacks, however, particularly in relation to rare earth oxide materials. Firstly, materials prepared by IWIT may have incomplete pore structures, resulting from incomplete impregnation of the pores of the template by the precursor. This is thought to be caused by guests within the mesoporous framework such as residual water, solvent or pockets of air, and may be exacerbated by the use of precursors which have difficulty entering the mesoporous template; for example, concentrated, viscous or high surface tension solutions. Secondly, largely because of this incomplete filling of the template by the precursor, the precursor may form amorphous or nanocrystalline particles which remain outside of the template. These particles therefore form outside of the resulting mesoporous phase. Not only do they represent lost material, but these particles, and indeed nanowires formed from the precursor during the calcination step, may also block the pores of the mesoporous product itself. Both of these factors may lead to reduced specific surface area (SSA).

Vacuum impregnation (VI) methods, in which the template is exposed to a reduced pressure before or during impregnation, have been shown to give comparable or improved results in some cases. For example, in CN102583255, Wang et al. describe use of a soft vacuum (ca. 0.5 atm) to prepare mesoporous transition metal and mixed-transition metal oxides. The KIT-6 silica templates are removed using HF to leave crystalline mesoporous oxides.

Kong et al., Journal of Porous Materials (2011) 18:107-112 similarly report the synthesis of mesoporous oxides using KIT-6 and SBA-15 silica templates. By vacuum-infiltrating the templates with aqueous metal nitrate solutions, calcination and digesting the template with hot sodium hydroxide, these workers were also able to produce good quality mesoporous cobalt, nickel and chromium oxides. These transition metal oxides yielded high angle reflections in powder X-ray diffractometry (PXRD) indicative of crystallinity or nanocrystallite alignment in the pore walls and low angle reflections characteristic of the longer range mesoporous structure. However, high angle PXRD of rare earth metal oxides (of lanthanum, neodymium and samarium) were consistent with the pore walls having an amorphous structure.

It is an object of the invention to mitigate one or more of the foregoing disadvantages associated with mesoporous rare earth containing oxide materials.

### SUMMARY OF THE INVENTION

According to an aspect of the invention, there is provided a method of making a mesoporous rare earth oxide material, the method comprising;
at a reduced pressure, contacting a mesoporous template with a precursor solution that comprises a rare earth metal salt or a neutral complex of a rare earth metal, so as to impregnate the mesoporous template;
calcining the impregnated mesoporous template to form a rare earth oxide material in situ; and
removing the mesoporous template from the calcined material.

The mesoporous rare earth oxide material is a mesoporous oxide of one or more metal elements in which at least one of these metal elements is a rare earth element. Typically at least 5 mole % of the metal elements present is of a rare earth element or mixture of rare earth elements. The mesoporous rare earth oxide material may contain more than one rare earth metal element and may in addition contain one or more transition metal and/or one or more main group metal elements.

The method is simpler and more straightforward than conventional IWIT methods. Moreover, the use of reduced pressure to impregnate the mesoporous template may give rise to more complete impregnation and, consequently, to improvements in the resultant mesoporous rare earth oxide materials; in terms of the overall yield and purity of the mesoporous product and/or the average crystallite size of the mesoporous product. The quantities of by-products such as nanoparticulate or nanowire oxide material, which may be disposed on the surfaces and/or in the pores of the mesoporous rare earth oxide material, may be reduced. These improved properties may be reflected in measured specific surface area, specific pore volume and/or pore size distributions (or combinations thereof). The improved properties may also be vising in microscopy, such as transmission electron microscopy (TEM) or high-resolution HRTEM.

The precursor solution may be a non-aqueous solution. For example, the precursor solution may be a solution of one or more metal salts and/or neutral complexes in a solvent other than water, such as an alternative polar solvent. Examples of alternative polar solvents include an alcohol (e.g. ethanol, methanol, isopropanol) or a mixture including at least one alcohol. The non-aqueous solution may comprise, consist of or consist essentially of ethanol, or a mixture of ethanol and at least one other solvent that is not water.

The precursor solution may be a solution of one or more metal salts including a salt or salts of one or more rare earth metals. The precursor solution may be a solution of one or more metal salts but with at least one rare earth metal provided as a neutral complex. Mixtures of metal salts and/or neutral metal complexes are contemplated. As a yet further alternative the precursor solution may be substantially or essentially salt free, with all the metal components provided as neutral metal complexes.

By non-aqueous, we include solutions substantially of a solvent or solvents other than water. A non-aqueous solution may include more than one solvent. For example a non-aqueous solution may comprise a solvent and a co-solvent. That is to say, a solvent or solvents other than water may make up more than half (and typically much more than half, for example more than 70%, 80% or 90%) of the total volume of the solvent, the balance being made up by one or more co-solvents present in a smaller amount. A non-aqueous solution may comprise water, which may be present for example as a co-solvent and/or which may be introduced as water of hydration of a metal salt or neutral metal complex from which the solution has been prepared. Where the non-aqueous solution comprises water it may be present at less than 20%, or less than 10% or even less than 5% by volume of the solvent.

Use of a non-aqueous solvent may provide for a reduction in the surface tension (and/or viscosity and/or density of the precursor solution (as compared to an aqueous solution of the same precursor salt(s) and/or complex(es)). This may facilitate impregnation into the pores of the mesoporous template. For example, the surface tension of ethanol-air (22.4 mNm⁻¹) is much lower than that of water-air (72.9 mNm⁻¹) at 20° C.), and the lower surface tension facilitates greater uptake of an ethanolic precursor solution in comparison to the corresponding aqueous solution.

In turn, impregnation may be possible using a precursor solution at a higher concentration than would be possible for a corresponding aqueous solution. Use of a non-aqueous solvent may give rise to other benefits. For example, a non-aqueous solvent may have increased volatility, thereby facilitating removal of the solvent during drying or calcination. The influence of water on the morphology or crystallinity of the oxide phase during its formation, which might otherwise result from the presence of coordinating or trapped water molecules, may also be reduced or prevented by the use of non-aqueous solvent.

The precursor solution may be a saturated solution. The precursor solution may comprise more than around 10 wt % of the precursor salt(s) and/or complex(es), or more than 20 wt % or more than 30 wt % or around 35-40 wt %.

Calcination of the impregnated mesoporous template may be performed at a temperature around or above 300° C., around or above 400° C., 500° C., 600° C., 700° C. or 800° C. Calcination may be conducted at a temperature of between around 300-700° C., or between around 400-600° C. The impregnated mesoporous template is calcined for sufficient time to convert the metal salt(s) and/or metal complex(es) to the oxides, under the conditions employed. The impregnated mesoporous template may be calcined for between around 1-10 hours, or between around 3-7 hours. The calcination may be conducted for around 4 hours or 5 hours.

Calcination is a process by which a material is heated to a high temperature in the presence of oxygen (e.g. in air). In the present method, the impregnated mesoporous template is heated to a temperature sufficient to cause the formation of a metal oxide material from the precursors in situ within the mesoporous template. The calcination temperature may be selected according to the nature of the precursor or precursors. For example, a metal nitrate salt may form an oxide material at a different temperature to a citrate salt. Calcination is conducted at a temperature below (and typically substantially below) the melting point of the oxide material which is formed.

The method may comprise calcining at more than one temperature. For example, calcination may be conducted in two (or more than two) phases; at a first temperature for a first period of time and at a higher second temperature for a second period of time. The temperature may be ramped gradually between the first and second temperatures. In one embodiment, for example, the impregnated mesoporous template is calcined at around 400° C. for around 4 hours, and at around 600° C. for around 4 hours. The temperature may be ramped gradually from 400 to 600° C. between over the course of, for example, an hour or several hours.

The second calcination phase may constitute a sintering or annealing step. That is to say, the method may comprise sintering or annealing of the impregnated mesoporous template.

Each calcination phase may result to some degree in the decomposition of the precursor or precursors. Each calcination phase may also include sintering or annealing. During sintering/annealing, particle growth, agglomeration of particles, densification and increase in crystallinity of the material contained in the pores of the template may occur. Typically, a greater part (and possibly a substantial part or substantially all) of the decomposition of the precursor salt occurs during the first calcination phase. A greater part (and possibly a substantial part or substantially all) of the sintering/annealing may occur during the second calcination phase.

Although not wishing to be bound by theory, it is thought that the two stage process of calcination may facilitate alignment of crystallites and/or an increase in the crystallinity of the metal oxide phase.

The mesoporous template may be removed by any suitable method known in the art.

The conditions for removing the mesoporous template may be selected according to the chemical nature of the mesoporous template and of the metal oxide material. For example, where the mesoporous template is formed from an organic compound, such as an organic polymeric material, or comprises mesoporous carbon, the template may be removed by heating in the presence of oxygen.

The mesoporous template may be chemically removed, by treating with a chemical capable of eroding or digesting the template. For example, removal of the mesoporous template may be effected by treatment with a solution of an acid or a base. In particular where the template is a silica or sodium silicate material, acid or base hydrolysis may be used, for example by treatment with a mineral acid solution such as HF or H₃PO₄(aq) or, in some embodiments more preferably an aqueous alkali metal hydroxide solution (e.g. NaOH(aq) or KOH(aq)).

A chemical treatment may be conducted for any suitable period of time, or may be repeated. A chemical treatment may be applied at an elevated temperature (above room temperature).

It is preferred for removal of a mesoporous template to be removed using the mild conditions, such as treating a silica mesoporous template with NaOH(aq) at room temperature. In comparison to treatment using harsher conditions, such as washing with concentrated, hot NaOH or HF solutions, it is believed that washing with NaOH (or other hydroxides) at room temperature and at modest concentration (e.g. between around 1-3 M, or around 2 M) is less likely to erode the oxide material which has been formed within the template. For example, treatment of rare earth oxide materials with particularly aggressive acidic or basic solutions may result in the formation of semi-amorphous oxy-hydroxides and hydroxides, or even result in dissolution of parts or all of the rare earth oxide material (see for example Bernal et al, J. Alloys & Compounds, 408-412 (2006) 496-502). Such aggressive treatments may therefore degrade crystallinity and/or pore order, even in cases where a rare earth oxide phase may be reformed on drying (which is not always the case).

The mesoporous oxide material may be an oxide of a single rare earth metal, or may be a mixed metal oxide material, comprising atoms/ions of a rare earth metal and one or more further metals.

The mixed metal oxide material may comprise atoms/ions of one or more further rare earth metals (such as gadolinium or yttrium) The mixed metal oxide material may comprise atoms/ions of one or more further transition and/or main group metals. (such as zirconium, strontium, chromium, manganese, cobalt or nickel)

The/each rare earth metal ion/atom may be a metal from the lanthanide series. The/each rare earth metal ion/atom may be scandium or yttrium. The/each rare earth metal ion/atom may be a metal selected from the group consisting of cerium, lanthanum, yttrium, gadolinium, scandium, praseodymium, neodymium, promethium, samarium, europium, terbium, dysprosium, holmium, erbium, thulium, ytterbium and lutetium. Preferably the/each rare earth metal ion/atom may be a metal selected from the group consisting of cerium, lanthanum, yttrium, gadolinium, scandium, praseodymium, samarium, terbium and ytterbium. More preferably the/each rare earth metal ion/atom may be a metal selected from the group consisting of cerium, lanthanum, gadolinium, samarium, and yttrium.

The mesoporous rare earth oxide material preferably comprises cerium. The mesoporous rare earth oxide material may be ceria or doped ceria.

Accordingly, where the precursor solution includes salts of the metals employed to form the oxide material when calcined, the precursor solution may comprise a single rare earth metal salt, or may comprise a mixture of a rare earth metal salt and one or more further metal salts in solution. Similarly where neutral metal complexes are used to provide one or more metal source, the precursor solution may comprise a single neutral rare earth metal complex, or may comprise a mixture of a neutral rare earth metal complex and one or more further neutral metal complexes in solution. Mixtures of one or more metal salts and one or more neutral metal complexes are contemplated.

Where the precursor solution has been prepared from more than one metal salt, the salts may be of the same anion (for example all of the salts may be nitrates or acetates or oxalates or alkoxides or citrates) or from different anions. Metal salts other than nitrates, acetates, oxalates, alkoxides or citrates may be employed. For example, oxychlorides. Where the mesoporous rare earth oxide material is to include zirconia, zirconium oxychloride may be employed (“ZrOCl₂” or “ZrOCl₂.8H₂O” actual formula [Zr₄(OH)₈(H₂O)₁₆]Cl₈(H₂O)₁₂]).

Where the precursor solution includes one or more neutral metal complexes, the complexes may make use of the same or different ligands for each metal complex employed. Ligands that may be employed in neutral complexes can include anionic co-ordinating ligands such as acetylacetonate (acac) or other β-diketones or ethylenediaminetetraacetate (EDTA) or its protonated form, EDTAH, For example a neutral complex of a rare earth metal may be Ce(acac)₃ or La(H₂O)₄(EDTAH) each of which may be provided as a hydrate. Other neutral complexes of rare earth metals are contemplated, for example Pr(Cp)₃ and Y(Cp)₃—where Cp is cyclopentadienyl—as sources of rare earth metal to form oxides on calcining.

The mesoporous template may be exposed to the reduced pressure and subsequently contacted with the precursor solution. The mesoporous template may be contacted with the precursor solution at an ambient pressure and the pressure may be reduced whilst the mesoporous template and the precursor solution are in contact. For example, the mesoporous material and in some cases also the precursor solution may be de-gassed by reducing the pressure above the precursor solution.

Reducing the pressure assists in removing gas, moisture or other trapped or adsorbed species from the pores of the mesoporous template.

The pressure may be reduced to a pressure below, and typically substantially below, ambient pressure (which is normally around 1 atm). The reduced pressure may, for example, be in the range of less than around 0.1 atm, or between around 10⁻²-10⁻¹¹ atm, or 10⁻⁶-10⁻⁸ atm. It has been found, for example, that a pressure of the order of 10⁻⁶ atm, as might be achieved using a rotary pump, is generally sufficient for the purposes of the present invention.

The mesoporous template may be placed at a reduced pressure before contacting with the precursor solution (and typically for a period when in contact therewith). The mesoporous template and the precursor solution may be contacted with one another and then placed at a reduced pressure.

The pressure may be reduced for a period of between around 10 minutes to 24 h, or between around 30 mins to 16 hours, or between around 1-10 hours or between around 4-6 hours. The precursor solution may be in contact with the mesoporous template for some or all of the said period (for example, around half of the said period).

Optionally, subsequent to contacting the mesoporous template with the precursor solution at a reduced pressure, the pressure may be increased whilst the mesoporous template and the precursor solution are in contact. For example, the pressure above the precursor solution, in which the mesoporous template is immersed, may be increased.

The pressure may be increased to ambient pressure or in excess of ambient pressure. The pressure may be increased to around or above 1 atm, 2 atm or 3 atm.

The mesoporous template may be contacted with the precursor solution for a period of between around 0-2 hours, or between around 0-30 minutes, prior to exposure to atmospheric pressure or above.

The method may comprise elevating the temperature of the precursor solution, prior to contacting with the mesoporous template, for example to a temperature in the range 30-60° C. The temperature of the precursor solution may be elevated for a period of time, for example of the order of hours (e.g. 6 hrs).

Elevating the temperature of the precursor solution may facilitate complete, or more complete, dissolution of the precursor or precursors employed.

The method may comprise elevating the temperature of the mesoporous template, for example to a temperature in the range 30-90° C. The mesoporous template may be at an elevated temperature during contacting with the precursor solution. This measure may prevent precipitation of the precursor or precursors, as they are contacted with the mesoporous template.

The method may comprise elevating the temperature of the vessel or vessels used to contact the precursor solution with the mesoporous template.

The method may comprise drying the impregnated mesoporous template, to remove a portion or substantially all of the solvent. The impregnated mesoporous template may be dried by gently heating, for example at a temperature between around 50-150° C., or between around 75-125° C., or between around 90-110° C. or 95-105° C. Alternatively or in addition the impregnated mesoporous template may be dried by exposure to a reduced pressure. For example, the impregnated mesoporous template may be separated from any excess precursor solution and dried under vacuum. Drying may also be facilitated by washing with a volatile solvent. As noted above, use of a non-aqueous solvent such as ethanol may facilitate the drying process.

The impregnated mesoporous template may be dried for a period of one or more hours (e.g. overnight) or as necessary, depending on the nature of the solvent and the template. It is within the ambit of a skilled person to select the required drying conditions based, for example, on observing changes in the mass and/or appearance of the material to be dried.

The method may also (or alternatively) comprise washing and/or drying the mesoporous rare earth oxide material, following removal of the mesoporous template.

Washing/drying may be required in order to remove any solvent or solutions used to remove the mesoporous template.

The method may comprise more than one of each of the steps mentioned above. The method may comprise repeating one or more said steps or a sequence of said steps.

In some embodiments, for example, impregnation of the precursor solution into the mesoporous template may be facilitated by contact with a precursor solution on more than one occasion. The method may for example comprise two or three or more cycles of; contacting the mesoporous template with precursor solution at reduced pressure, optionally washing, and drying the impregnated mesoporous template.

The method may comprise repeating a treatment to remove the mesoporous template. The method may for example comprise two or three or more cycles of; heating or chemically treating (e.g. with acidic or basic solution as described above) the calcined material, and washing and/or drying.

The method may comprise calcining the impregnated mesoporous template on more than one occasion. Calcination may be conducted between successive impregnation steps, for example.

The mesoporous template may be a silica or silicate (such as a sodium silicate or aluminosilicate) material. The mesoporous template may be of another class of mesoporous material, such as a mesoporous carbon material or a mesoporous polymeric material. The mesoporous template may be provided in the form of a powder or granular material. The mesoporous template may be provided in the form of a pressed pellet, formed from a powder or granules. A pressed pellet is easier to handle than a loose powder during reduced pressure operations and has been shown to work well in the methods of the invention. The pellet can be impregnated with the precursor solution, under reduced pressure, and then dried and calcined. Removal of the mesoporous template from the calcined material typically produces a powder form of mesoporous rare earth oxide material.

The method is not restricted to any particular structural type of mesoporous template, and may be applied to a mesoporous template having any selected pore size. For example the mesoporous template may be a silica material having a KIT-6, SBA-15, MCM-41, MCM-48 or an FDU-12 structure.

The mesoporous template may be prepared by any method known in the art, including sol-gel methods (soft-templating or co-operative self-assembly) and hard templating methods. Mesoporous silica such as KIT-6 or SBA-15 materials may for example be prepared in accordance with the methods described Kleitz at al., Chem. Commun., 2003, 2136-2139 and by Zhao et al., Science, 1998, 279, 548-552, respectively.

Where the mesoporous template is a carbon template it may itself be prepared by a similar method to that used to make the mesoporous rare earth oxide materials of the invention. For example a mesoporous carbon template may be formed as follows. A solution of an organic compound (e.g. a sugar, sucrose) is contacted with a silica template at reduced pressure. The sucrose impregnated silica is dried and the sucrose converted to carbon by addition of an oxidising agent, such as concentrated sulphuric acid, and/or heating to high temperature in an inert atmosphere (for example to 900° C. for 1 hour in Argon). Removal of silica using NaOH and drying leaves a mesoporous carbon template for use in preparing the mesoporous rare earth oxide material. The carbon template can be removed by heating in air, following impregnation by the precursor solution and calcination. Thus two applications of a reduced pressure method, first to prepare a mesoporous carbon template and then to prepare the mesoporous rare earth oxide material can be employed in methods of the invention.

It will be understood that, in common with other hard-templating methods, the mesoporous rare earth oxide materials produced in accordance with the methods described herein share the same structural type as the templates from which they are formed. Moreover, the pore sizes of the mesoporous rare earth oxide materials reflect that the aforementioned in situ oxide formation takes place within the pores of the template, such that the resulting mesoporous oxide may be considered to be a “negative” of the template from which it is formed. Accordingly, the porosity of the mesoporous rare earth oxide material may be characteristic of the spacing between the pores of the template.

In another aspect of the invention, there is provided a mesoporous rare earth oxide material obtained or obtainable by the method comprising; at a reduced pressure, contacting a mesoporous template with a precursor solution that comprises a rare earth metal salt or a neutral complex of a rare earth metal, so as to impregnate the mesoporous template;

calcining the impregnated mesoporous template to form a rare earth oxide material in situ; and

removing the mesoporous template from the calcined material.

Further preferred and optional features of the method are as set out in relation to other aspects of the invention.

The inventors have found that, in contrast to known techniques, the method is capable of producing a mesoporous rare earth oxide having a greater degree of order than has previously been possible.

The mesoporous rare earth oxide material may have a greater degree of order (by virtue of larger (e.g. continuous) crystal domains and/or a greater degree of alignment of nanocrystallites from which the material is comprised), than has previously been possible using vacuum impregnation techniques.

The mesoporous rare earth oxide material may be characterised by improved mechanical and/or thermal stability. Improved mechanical and/or thermal stability may result from more complete impregnation of the mesoporous template. For example, mesoporous templates such as SBA-15 or KIT-6 are known to comprise nanopores which link the mesoporous networks. The present invention may provide for more complete impregnation of the nanopores, in turn leading to a greater number density of linking nanoscale structures of the mesoporous rare earth oxide material. Indeed more complete impregnation of the mesopores themselves may result from the use of reduced pressures as described herein, which may lead to larger or more ordered mesoporous domains.

These improved properties may be reflected in measured specific surface area, specific pore volume and/or pore size distributions (or combinations thereof).

For a material having a specific surface area within a particular range, specific pore volume may be closer to a theoretical value (calculated for a “perfect” material) than has previously been possible for example using IWIT methods. For example, in some embodiments, the SSA of a mesoporous material obtained/obtainable using an IWIT method may be similar to that of a mesoporous material made in accordance with the present invention (e.g. of the order of 100-150 m²g⁻¹), whereas the specific pore volume of the IWIT material may be lower (e.g. 20-30% or more lower) than the specific pore volume of a mesoporous material made in accordance with the present invention. The specific pore volume of the materials of the present invention may, in comparison, be greater than 50% or around 60% or more of the theoretical value.

The specific surface area of a sample of a mesoporous material will include contributions from both the mesopore structure itself as well as from any nanoparticulate by-products such as nanowires, as described above. Accordingly, the observation that materials obtained by way of the method described herein have generally similar specific surface area but significantly greater specific pore volumes than materials obtained using conventional IWIT methods, is suggestive of improved mesoporous structures.

The improved properties may also be vising in microscopy, such as transmission electron microscopy (TEM) or high-resolution TEM (HRTEM).

The improved order may be reflected both in powder XRD patterns having high angle reflections (20 greater than around 10 degrees, using copper K_{α} X-rays) characteristic of the crystal structure of the rare earth oxide phase, and in low angle X-ray scattering (20 less than around 10 degrees, and more typically less than around 5 degrees, using copper Kₐ X-rays) characteristic of the ordered mesopore network. Digital diffraction patterns (DDPs) obtained from regions of TEM images by fast Fourier transform (FFT) may also indicate mesoporous ordering.

The pore walls (i.e. the material defining the mesopores) of the material may be crystalline (which may be visible in HRTEM images for example), or may be composed of aligned (as opposed to randomly oriented) crystallites.

The increased size of the produced mesoporous crystallites may be reflected in the peak width of power XRD patterns, for example the full width at half height, or the estimated average particle size obtained by applying the Scherrer equation to these peak width values.

The improved properties of the mesoporous rare earth oxide materials obtained or obtainable in accordance with the invention may be characterised by one or a combination of these properties. Thus, the invention extends in further aspects to a mesoporous rare earth oxide material characterised by one or more of;
A specific pore volume greater than 50% or around 60% or more of the theoretical value;
Power XRD patterns showing high angle reflections characteristic of the crystal structure of the rare earth oxide phase, and low angle X-ray scattering and/or DDP data characteristic of the ordered mesopore network;
Power XRD patterns with peak widths indicative of average crystallite sizes in the range of at least 20 nm, or between around 20-40 nm; as obtained from the Scherrer equation;
mesopores defined by crystalline rare earth metal oxide material and/or aligned crystallites of rare earth oxide material (as compared to amorphous oxide, or a disordered arrangement of crystallites, as obtained from known methods).

It will be appreciated that comparative values of the various parameters (SSA, specific pore volume, crystallinity and the like) may be used to compare the materials obtained/obtainable in accordance with the invention. However, typical methods used are as follows:

Analysis of N₂ physisorption/desorption isotherms may yield specific surface area and specific pore volume measurements (calculated using the Brunauer-Emmett-Teller method, Brunauer et al JACS 60 (1938) 309-319) and pore size distributions (calculated using the Barret-Joyner-Halenda method, E. P. Barrett et al, JACS 73 (1951) 373-380).

Average crystallite size may be determined from the powder X-ray diffractometry patterns, using the Scherrer equation (Klug, H.; Alexander, L. In X-ray Diffraction Procedures for Polycrystalline and Amorphous Materials: John Wiley: New York, 1974; pp 618) and a Scherrer constant K_{w} of 0.855. It will be understood that the particle sizes predicted in this manner represent a mathematical fit to an equation based on certain approximations and assumptions (including that the composition consists of particles in the nano-particle size range, and comprising particles which are spherical in shape) and, accordingly, may not reflect actual particle sizes present in the composition.

Theoretical specific pore volume values were obtained as follows. The specific pore volume of the relevant template was experimentally determined from physisorption experiments. The pores were assumed to be completely filled by the solidified precursor material (e.g. the rare earth nitrate) and this was assumed to decompose to the pure final product (e.g. the rare earth oxide). By considering the densities of these phases (obtained from the literature or from XRD data) the theoretical pore volume per unit mass (the specific pore volume) was obtained.

In another aspect of the invention, there is provided the use of a mesoporous rare earth oxide material of other aspects of the invention as a redox catalyst. The mesoporous rare earth oxide material may be used to catalyse an oxidation process and/or a reduction process.

The activity of the catalysis may be enhanced by the increased order of the materials of the present invention. For example, a reduction in the amount of extraneous material in and around the mesoporous crystallites may improve diffusion of reactive species to catalytically active sites within the framework. Indeed, it may be that the increased order present in the pore walls of the mesoporous frameworks is associated with an increase in the concentration or accessibility of catalytically active sites. The mechanical and thermal stability of these mesoporous rare earth oxide materials can also contribute to their utility as catalysts.

Further advantages may be obtained. Without wishing to be bound by theory the mesoporous rare earth oxide materials of the invention are forced to crystallise within a constrained space (the mesopores of the template). The mesoporous rare earth oxide materials of the invention can have relatively large single crystalline regions (in which lattice planes are parallel over relatively large distances as illustrated by specific examples described hereafter).

These crystalline regions have had to accommodate themselves in the geometry of the mesopores of the template, leading to the possibility of unusual crystal facets forming at the surfaces of the material (which may not have formed or only to a lesser extent if the material had crystallised in the absence of the constraining template).

When the template is removed, it is possible that these unusual crystal facets will change the relative numbers of surface sites of different types at the surface of the material, in comparison with other materials. This may alter the catalytic performance of the material in terms of activity and/or selectivity.

In addition, as can be seen in transmission electron micrograph (TEM) figures and the associated digital diffraction patterns (DDP) of exemplary materials described in detail hereafter, the crystal structures often gradually change orientation across the images—the planes are gently curved rather than being straight. This phenomenon may signify a strained crystal structure in which some interatomic distances and/or interplanar spacings may be different from their normal values. Again, this may affect catalytic performance, in terms of selectivity and/or activity.

The mesoporous rare earth oxide material may be used as a catalyst in a process which comprises both oxidation and reduction of species contacting the catalyst.

The mesoporous rare earth oxide material may be used as a redox catalyst in an exhaust stream (for example in automotive or energy generation applications) as a two way catalyst (i.e. as a catalyst for a process in which oxidation of carbon monoxide and hydrocarbons or the products of partial hydrocarbon combustion into carbon dioxide and water takes place).

The mesoporous earth oxide material may be used as a redox catalyst in an exhaust stream as a three way catalyst (i.e. as a catalyst for a process in which oxidation of carbon monoxide and hydrocarbons or the products of partial hydrocarbon combustion into carbon dioxide and water, and reduction of nitrogen oxides to nitrogen and oxygen, takes place).

For example, ceria and doped ceria materials such as gadolinium, samarium or zirconium doped ceria are known to be used as 2- and 3-way redox catalysts and the present invention provides new mesoporous ceria materials for use in these applications. The redox catalyst may for example, comprise doped ceria of the formula CeₓM₁₋ₓO_{2-δ}, where M is a main group, transition or rare earth metal element; x and δ are independent and typically in the range of 0-1, or 0-0.5. M may be a transition, main group, or rare earth metal. M may be Zr, Gd or Sm.

For further example pure and doped oxides of La, Tb, Nd, Pr and pure and doped perovskites of general formula LMO₃ (where L is La, Tb, Nd or Pr and M is a transition metal) may also be used. More generally L may be any of the 17 rare earth metals in the formula LMO₃ (cerium, lanthanum, yttrium, gadolinium, scandium, praseodymium, neodymium, promethium, samarium, europium, terbium, dysprosium, holmium, erbium, thulium, ytterbium and lutetium).

The invention also extends in another aspect to the use of a mesoporous rare earth oxide material of other aspects of the invention as an electrode, and in particular as a fuel cell electrode. The electrode may be a solid oxide fuel cell electrode.

In yet another aspect, the invention extends to the use of a mesoporous rare earth oxide material of other aspects of the invention as an electrolyte material of a fuel cell, such as a solid oxide fuel cell.

The mesoporous rare earth oxide material may be used as an electrode and/or an electrolyte in an intermediate temperature solid oxide fuel cell. An intermediate temperature fuel cell may operate at a temperature of between around 300-900° C., or between around 400-800° C., or between around 450-700° C.

In addition to the advantages conveyed to their redox catalytic properties described above, which apply equally to their use in fuel cell application, the mechanical and thermal stability of these materials may be beneficial to their use in fuel cell applications. In addition, the increased order within the mesoporous frameworks may give rise to improved electrical properties and thus improved electrode and/or electrolyte performance. For example, lower temperatures may allow the use of cheaper, more conventional materials in SOFC components, such as housings, electrical contacts, pipework and other ancillary plant. Lower temperatures may also reduce aging effects of fuel cells, their components and ancillary plant, because of lower thermal stress and less aggressive thermal and chemical cycling during start up/switch off and during changes in power drawn.

The mesoporous rare earth oxide material for use as a fuel cell electrode and/or electrolyte may for example be an yttria-stabilized zirconia material or a scandium-stabilized zirconia material (having a composition which may be represented as (M₂O₃)ₓ—(ZrO₂)₁₋ₓ where M is Y or Sc and x is less than 0.2 and above 0, or between around 0.08-0.10), a ceria or doped ceria material (e.g. of the formula CeₓM₁₋ₓO_{2-δ}, where M is a main group, transition or rare earth metal element; x and δ are independently typically in the range of 0-1, and 0-0.5, respectively. M may be a transition, main group, or rare earth metal. M may be Sm, Gd or Zr) or a lanthanum-based perovskite material (such as a lanthanum gallium oxide, a lanthanum cobalt oxide, or a doped lanthanum gallium or cobalt oxide, which may be doped with an element such as strontium, for example).

The mesoporous rare earth oxide material for use as a fuel cell electrode and/or electrolyte may be essentially pure O²⁻ ion conductors (for use for example as electrolytes or as the ionically conducting component of a multi-component electrode), or may be mixed conductors of O²⁻ ions and electrons (for use for example in electrodes).

Such materials may also be catalytically active, particularly where electron conduction takes place. Yttria-stabilized zirconia, scandium-stabilized zirconia, Gd- and Sm-doped ceria (at 0<x<0.3) and lanthanum gallium oxides are examples of good oxygen ion conductors. Mixed Ce/M oxides (where M is Zr, or Sm, for example), when operating under reducing conditions, are examples of mixed conductors.

Optionally, anodes may comprise such materials mixed with a further (e.g. metal) phase to modify electronic conductivity and/or catalytic activity.

According to a still further aspect of the invention there is provided the use of a mesoporous rare earth oxide material of other aspects of the invention in a photovoltaic device.

The mesoporous rare earth oxide material may be used as a solid support for a photovoltaic material, such as a photoactive dye (these may for example be porphyrins, metal polypyridine complexes such as e.g. [Ru(4,40-dicarboxy-2,20-bipyridine)₂(NCS)₂], and [Ru(4,4′,4″-(COOH)₃-terpy)(NCS)₃], doped copper-diselenium, [Cu(In,Ga)Se₂], hybrid perovskites such as CH₃NH₃PbI₃ or metal-free compounds such as 1-ethyl-3 methylimidazolium tetrocyanoborate [EMIB(CN)₄]) and conjugated polymers alone or incorporating dyes such as 4,4-Difluoro-4-bora-3a,4a-diaza-s-indacene (BODIPY)). The mesoporous rare earth oxide material may provide a conduction pathway for photoexcited electrons, in use of the photovoltaic device.

The mesoporous rare earth oxide material may be used in a solar cell, for example as a bulk heterojunction.

Whereas semiconducting oxides or ceramics such as TiO₂ are currently employed for such applications, the use of semiconducting mesoporous rare earth oxides as described herein as a substrate may provide for increased loading of photovoltaic materials. In addition, the improved order/crystallinity of these materials may correspond to improved electrical properties in use and so give rise to increases in photovoltaic performance or efficiency.

In a still further aspect of the invention, there is provided an article comprising a mesoporous rare earth oxide material in accordance with other aspects.

The article may comprise a redox catalyst. For example, the article may comprise a cartridge for use in an exhaust stream, such as a vehicle exhaust or any other combustion exhaust (such as from a power generator or the like). The article may be a catalytic converter for a vehicle.

The article may be a fuel cell electrode. The fuel cell electrode may comprise one or more further components, such as a substrate. The mesoporous rare earth oxide material may be mixed with a metallic component, such as a metal powder (e.g. nickel, copper).

The article may be a fuel cell electrolyte structure. The article may comprise both a fuel cell electrode and an electrolyte structure.

The mesoporous rare earth oxide material of the electrode and electrolyte structure may be the same (i.e. of the same oxide) or similar (i.e. comprising one or more common metals, and/or having a common crystal structure type). An electrode material may differ from a similar electrolyte material for example in terms of the number of oxygen ion vacancies in the oxide crystal lattice (i.e. 8) and/or the nature or extent of doping. It may for example be desirable for the electrode material to have a less complete oxygen lattice so as to improve ionic conductivity, whereas it may be preferable for the electrolyte to have lower levels of doping, for example to reduce electronic conductivity.

The electrolyte may be of higher density, or comprise higher density regions, than the electrode structure. For example, the electrode may be formed from a greater amount (e.g. entirely) from a mesoporous rare earth oxide material, whereas the electrolyte may comprise another structural form.

Commonality in the materials used for the electrode and electrolyte may reduce interfacial stresses at high temperature. Commonality in the materials used may also reduce or prevent solid state reactions which might otherwise occur between dissimilar materials (such as might ultimately degrade their performance, e.g. physical and/or electrical properties).

The article may be a fuel cell, in which one or more electrodes or an electrolyte structure comprises a mesoporous rare earth oxide material in accordance with the invention.

The article may be a photovoltaic device. The photovoltaic device may be a bulk heterojunction. The bulk heterojunction may comprise a said mesoporous rare earth oxide material impregnated with a photoactive dye. The bulk heterojunction may be made by contacting the mesoporous rare earth oxide material with a dye, or a solution comprising the dye, at reduced pressure. This may improve impregnation of the dye into the pores of the mesoporous rare earth oxide material.

The article may be a solar cell, comprising a said bulk heterojunction.

Further preferred and optional features of each aspect of the invention correspond to preferred and optional features of each other aspect of the invention.

### DESCRIPTION OF THE DRAWINGS

Example embodiments will now be described with reference to the following drawings in which:

FIG. 1 is a schematic diagram of apparatus used to perform vacuum impregnation of mesoporous templates;

FIG. 2. shows powder XRD patterns of (a) Ceria-S; (b) CGO-S; (c) Ceria-K; (d) CGO-K; (e) Ceria-X reference material. An explanation of the sample nomenclature is set out below.

FIG. 3 shows: (a) Physisorption isotherms and (b) pore size distributions for the SBA-15 template and the products obtained using it. In (b), the lines in bold are from the desorption isotherm and lighter lines from the adsorption isotherm.

FIG. 4 shows Small Angle X-ray Scattering patterns for (a) SBA-15; (b) Ceria-S; (c) CGO-S. Miller indices related to the hexagonal pore structure are indicated.

FIG. 5 shows TEM images of the SBA-15 template showing: (a) the hexagonal arrangement of cylindrical pores viewed in the [001] zone axis with DDP inset; and (b) several particles with their pore structure viewed primarily in the [100] direction.

FIG. 6 shows TEM images of Ceria-S. (a) Particles showing widespread mesoporous material including particles viewed along the [100] and [001] zone axes of the hexagonal pore structure. (b) High resolution image of mesoporous material. Bridges between the rods are circled and the interpore and interplanar distances are indicated. (c) DDP of image B showing the 111 spot of ceria. (d) Enlargement of centre of the DDP from C showing spots related to the pore structure. (e) Reverse Fourier Transform of spots in D showing the pore structure in real space.

FIG. 7 shows TEM images of CGO-S. (a) Particles showing widespread mesoporous structure (arrowed). (b) High resolution image of mesoporous material. Bridges between the rods are circled. (c) DDP of image (b) showing the 111 spot of CGO.

FIG. 8 shows (a) Physisorption isotherms and (b) pore size distributions for the KIT-6 template and the products obtained using it. In (b), lines in bold are from the desorption isotherm and lighter lines from the adsorption isotherm.

FIG. 9 shows Small Angle X-ray Scattering patterns for (a) KIT-6; (b) Ceria-K; (c) CGO-K. Miller indices related to the cubic pore structure are indicated.

FIG. 10 shows TEM images of the KIT-6 template showing: (a) the extent of the pore structure with a DDP (inset) of a region (circled) of pores viewed in the [210] zone axis; and (b) a high resolution image of the cubic pore structure.

FIG. 11 shows TEM images of Ceria-K. (a) Particles showing widespread mesoporous material including particles viewed along the [311] zone axis of the cubic pore structure. (b) High resolution image of mesoporous material viewed along the zone axis of the pore structure. (c) DDP of image (b) showing the full pattern of ceria viewed along the [110] crystallographic zone axis.

FIG. 12 shows TEM images of CGO-S. (a) Particles showing widespread mesoporous structure (arrowed). (b) High resolution image of mesoporous material showing the pore structure and crystal planes. (c) DDP of image (b) showing the full pattern of CGO viewed along the [110] crystallographic zone axis.

FIG. 13 shows TPR spectra of (a) nanoparticulate ceria reference; (b) CGO-K; (c) Ceria-K; (d) Ceria-S and (e) CGO-S

FIG. 14 is a schematic diagram of a dye-sensitised solar cell;

FIG. 15 shows photoluminescence (PL) results for standard and reduced Ceria-K and silica and titanium oxide reference materials.

FIG. 16 (a)-(f) show TEM images from in-situ heating of CGO-K. The series of images was taken as the temperature was increased from room temperature to 1000 CC. FIG. 14(g) shows a TEM image of the sample after the heating experiment. The digital diffraction patterns (DDPs) are shown adjacent to the TEM images, acquired from the particle circled in (a).

FIG. 17 shows plots comparing the effect of thermal treatment on (a) specific surface area and (b) pore volume for various mesoporous ceria-based materials with specific surface area and pore volume losses shown for the CGO-S product. The substances plotted are as follows: 1 (-♦-) CGO-S; 2 (-●-) ceria synthesised using P123 non-ionic surfactant as described in M. Lundberg et al, Microporous and Mesoporous Materials, 54 (2002) 97; 3 (-●-) ionic templated ceria (heated for 4 h) as described in J. A. Wang et al, Chemistry of Materials 14 (2002) 4676; 4 (-●-) ionic templated ceria (heated for 2 h) as described in A Trovarelli et al Journal of Catalysis 178 (1998) 299; and 5 (-♦-) ionic templated ceria (heated for 2 h) as described in L. Pino et al, Materials Technology 20 (2005) 18.

### DETAILED DESCRIPTION OF EXAMPLE EMBODIMENTS

Disclosed herein is a new method for impregnating/infiltrating a mesoporous template under vacuum (reduced pressure), to prepare mesoporous rare earth oxide materials. The novel “vacuum impregnation” (VI) methods of the present invention reduces the reliance on capillary action for the incorporation of the precursor salt solution into the mesoporous template. The method has yielded better results than the traditional incipient wetness impregnation technique (IWIT) and is both simpler and quicker to perform.

### Experimental

Mesoporous silica templates SBA-15 and KIT-6 were synthesised following procedures available in the literature, as described by Zhao et al, Science 279 (1998) 548 and Kleitz et al, Chemical Communications (2003) 2136. and In a typical synthesis of SBA-15, 2 g of the non-ionic surfactant, Pluronic P123 (EO₂₀PO₇₀EO₂₀; where EOₙ is poly(ethylene oxide) and POₙ is poly(propylene oxide), was added to 15 cm³ deionized water and 60 cm³ of 2M HCl and stirred at 40° C. for 8 h. The Pluronic surfactant was obtained from Sigma-Aldrich. Pluronic is a trademark of BASF.

4.25 g tetraethylorthosilicate (TEOS 99%; obtained from Fluka) was added and stirred for 24 h at the same temperature. This mixture was hydrothermally treated at 100° C. for 24 h in a Teflon container. Teflon is a trademark of the DuPont Chemical Company. The resulting white solid was filtered, washed and dried. The surfactant was removed by calcining at 500° C.

In a typical synthesis of KIT-6, 6 g of Pluronic P123 was added to 180 cm³ deionized water and 50 cm³ of 2M HCl and stirred at 35° C. for 6 h. 6 g of n-butanol (Sigma, 99%) was added and stirred for 1 h. 12.48 g TEOS was added and the mixture was stirred at the same temperature for 24 h followed by hydrothermal treatment as above. The resulting white solid was filtered, washed and dried. The surfactant was removed as above.

The precursor salt solutions used to make the mesoporous rare earth oxide materials described below were prepared by dissolving in 0.5 cm³ of ethanol either 1 g of the metal nitrate, e.g. Ce(NO₃)₃.6H₂O; (Acros, 99.5%) to prepare mesoporous CeO₂ or 1 g of a mixture of nitrates, e.g. a 9:1 molar ratio of the Ce(NO₃)₃.6H₂O and Gd(NO₃)₃.6H₂O (Alfa Aesar, 99.9%) to prepare the Ce_{0.9}Gd_{0.1}O_{1.9} (CGO).

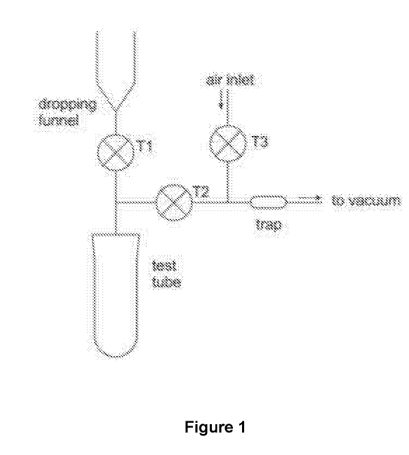

Apparatus for performing vacuum impregnation is shown schematically in FIG. 1. The VI method used is as follows:

Initially, all taps were closed. A particle trap was placed in line with the vacuum pump to prevent contamination of the rotary pump used to apply the vacuum.

In a typical VI experiment a volume of template (0.1-2.0 g depending on the experiment) was placed into the test tube. The apparatus was then assembled as per FIG. 1.

The rotary pump was switched on and tap T2 was opened slowly to ensure no template was sucked down the vacuum line (due to the light and voluminous nature of the template). The test tube was tapped lightly to help remove air pockets during the early stage of the evacuation process. The template was then left to evacuate for 4-6 h.

A precursor solution consisting of the impregnating salt (or other precursor material), was stirred for at least 6 h at 30-60° C. to ensure it was a homogeneous mixture. The solutions used in this work were ethanol saturated with Ce(NO₃).6H₂O, or ethanol with replacement of 10 mol % of the cerium salt by Gd(NO₃).6H₂O.

The volume of precursor solution used in the impregnation step exceeded the volume required to impregnate all of the pores in the template in order to ensure the vacuum was not compromised during impregnation by ingress of air through the dropping funnel. The solution was placed in the dropping funnel and left for any air bubbles to dissipate.

T2 was closed and the pump was switched off.

T1 was opened slowly at first to allow the solution to completely cover the template and then, once sufficient volume of solution was admitted to completely impregnate the template, T1 was closed.

Accordingly, at this stage, and at the reduced pressure, the mesoporous template was contacted with the precursor solution.

T2, and then T3 were opened to return the system to atmospheric pressure and complete the impregnation. This could be observed by rapid infiltration of the precursor solution into the template.

Excess solution was then decanted before the sample was dried at 95-105° C. in air in an oven.

The sample was calcined at 400 and 600° C. in air for 5 h at each temperature (ramp rate 1° C. min⁻¹) using a tube furnace.

The silica template was dissolved by stirring with approximately 20 cm³ of 1-2 M NaOH. Centrifugation was used to recover the product from the solution. This step was repeated three times. The product was then dried in an oven at 105° C. overnight.

For the materials used for the photovoltaic work, a vacuum desiccator was used instead of a test tube and a water pump was used instead of a rotary pump. The precursor solution was added directly into the air inlet. After the product was dried at 95-105° C. in air in an oven, the sample was calcined at 400° C. in air for 5 h (ramp rate 1° C. min⁻¹), and then impregnated a second time. After this the sample was calcined at 400 and 600° C. in air for 5 h at each temperature (ramp rate 1° C. min⁻¹), before the silica template was dissolved by stirring with approximately 20 cm³ of 1-2 M NaOH. Buchner filtration was used to recover the sample from the solution. The sample was sucked dry. This step was repeated three times.

Products are referred to below by their composition (Ceria or CGO) and with a suffix to represent the mesoporous template used to prepare them (-S for SBA-15 and -K for KIT-6).

For comparison, a nanoparticulate but non-mesoporous ceria (which is referred to below as “Ceria-X”) was produced without the use of a template, by calcining cerium citrate (prepared from Ce(NO₃)₃.6H₂O and citric acid (Alfa Aesar, 99.5%).

A Micrometrics ASAP 2020 instrument operating at 77 K was used to obtain Brunauer-Emmett-Teller (BET) Nitrogen adsorption/desorption isotherms, Specific Surface Areas (SSAs) and Barret-Joyner-Halenda (BJH) pore-size distributions (PSD) of all products.

Powder X-Ray Diffraction (XRD) data was collected using a Philips PW 1710 diffractometer with Cu Kₐ radiation (λ=1.54 Å). Scan rates in a typical experiment were 1° min⁻¹ over a range of 2θ=10-80°. Peak-width analysis was performed by fitting a Gaussian curve to the raw data and applying the Sherrer equation in order to obtain estimates of average crystallite size (see Klug, H.; Alexander, L. in: X-ray Diffraction Procedures for Polycrystalline and Amorphous Materials, John Wiley, New York, 1974, p. 618).

Small-angle X-Ray Scattering (SAXS) patterns were collected using a Hecus X-ray Systems Generation 1 instrument incorporating a modified compact Kratky camera with slit focussing and a PSD. Samples were run using a SpiCap attachment and with Cu Kₐ radiation at 40 kV and 30 mA. Data were analysed using FindGraph peak-fitting software.

Transmission Electron Microscopy (TEM) images were recorded using a JEOL JEM 2011 instrument fitted with a LaB₆ filament and operating at 200 kV. Semi-quantitative elemental analysis by Energy-dispersive X-ray Spectroscopy (EDS) was performed using the Oxford Instruments X-Ray analysis ISIS 300 detector mounted on the TEM instrument. The DigitalMicrograph 3.4.4 graphics suite (Gatan) was used to analyse the TEM images and to obtain Digital Diffraction Patterns (DDPs) from the images by fast Fourier transform. Unless stated, no TEM images were manipulated using inverse-FFT functions. Elemental analysis on bulk samples was performed by Inductively Coupled Plasma—Mass Spectrometry (ICP-MS) using an Agilent 7500 instrument.

Temperature-programmed reduction (TPR) experiments were collected using custom-built TPR equipment coupled to a quadrupole mass spectrometer system. The sample was heated from ambient to 800° C. at 5° C./min under a flow of 5% H₂ in Ar.

Temperature-programmed desorption (TPD) experiments were performed in the same way but under a flow of pure Ar. 50 mg of sample was used in each experiment, gases were passed through water and oxygen filters prior to use and flow rates were 45 cm³ min⁻¹. TPR experiments were run under identical mass spectrometer and other settings to allow direct comparison of the spectra.

Results and Discussion

Powder XRD

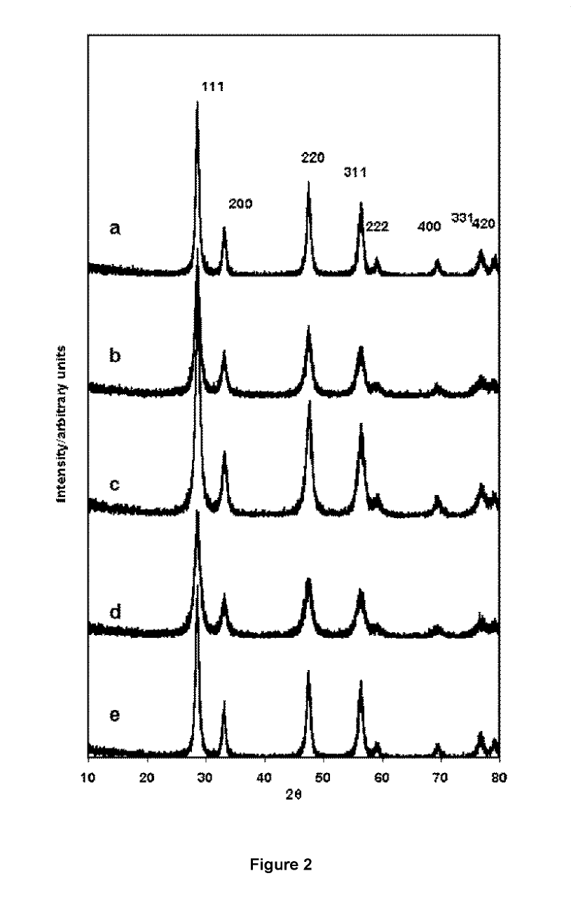

Powder XRD patterns for all four products—Ceria-S, Ceria-K, CGO-S and CGO-K—as well as the nanoparticulate CeO₂ (Ceria-X) are shown in FIG. 2. All patterns could be indexed to the cubic Fluorite structure (Fm3m with a˜5.41 Å) expected for pure CeO₂ and for the CGO and there was no evidence of any impurity phases. Peak broadening is seen in the patterns for all materials which is indicative of small crystallites. Using the Scherrer approach, estimates of average crystallite size were found to be in the range 23.5-34.2 nm for the four products and 32.9 nm for the Ceria-X reference. The data are presented in Table 1 and are discussed below. As mentioned above, the assumptions upon which the Scherrer equation is based—especially regarding the particles as being close to spherical in shape—may not be applicable to the present materials. Accordingly, whilst these average crystallite sizes may be compared with one another, they may not in all cases be quantitatively representative of actual average crystallite sizes in a sample.

TABLE 1
Summary of structural data for the four products: average crystallite
size (D) from XRD line broadening; SSA and specific pore volume
(Vₚ) from gas sorption experiments; pore sizes (dₚ) from maxima
in the BJH pore size distribution plots; pore spacings from DDPs
of TEM images (d_{TEM}) and the SAXS patterns (d_{SAXS}).

| | D | SSA | Vₚ | dₚ | d_{TEM} | d_{SAXS} |
|---|---|---|---|---|---|---|
| | (nm) | (m²g⁻¹) | (cm³g⁻¹) | (nm) | (nm) | (nm) |
| SBA-15 | — | 800-890 | 1.0-1.1 | 5.9-7.3 | 7.5-8.6 | 9.3 |
| Ceria-S | 34.2 | 85.7 | 0.29 | 2.4-3.0, | 8.9-9.7 | — |
| | | | | 9.6-13.8 | | |
| CGO-S | 23.5 | 108.6 | 0.32 | 2.5-3.0, | 8.7-9.8 | 9.2 |
| | | | | 11-17 | | |
| KIT-6 | — | 840-990 | 1.2-1.4 | 6.4-7.2 | 8.9-10.5 | 9.6 |
| Ceria-K | 24.3 | 114.7 | 0.35 | 2.2-3.0, | 8.5-9.4 | — |
| | | | | ~8 | | |
| CGO-K | 22.5 | 137.5 | 0.38 | 2.1-2.7 | 9.1-9.2 | 8.8 |
| | | | | ~8 | | |

Comparison experiments were conducted on a mesoporous ceria obtained using a conventional IWIT method. The IWIT mesoporous ceria had a SSA of 129 m²/g (i.e. comparable to the SSA of the Ceria-K and CGO-K materials listed in table 1), a dₚ value of 4-10 nm (i.e. less defined pore sizes than for Ceria-K and CGO-K) and a Vₚ, of 0.25 cm³/g (i.e. significantly smaller than the Vₚ of Ceria-K and CGO-K).

Chemical Composition

Using the EDS method in the TEM the Ceria products were confirmed to contain Ce and O and the CGO products Ce, O and Gd. The only impurity was Si, undoubtedly remaining from the templates, which was detected in all samples at levels of 4.5, 6.2, 6.0 and 6.3 mole % for Ceria-S, Ceria-K, CGO-S and CGO-K, respectively. EDS mapping showed no local concentrations of Si. Rather, it appeared to be distributed evenly throughout each sample, at least at the effective resolution of the instrument used (˜5-10 nm). Molar Ce:Gd ratios were measured to be 11:1 and 10:1 for CGO-S and CGO-K. Analysis by ICP-MS gave values of 2 to 4 mol % Si content for these samples.

Structures of SBA-15, Ceria-S and CGO-S

Gas Physisorption

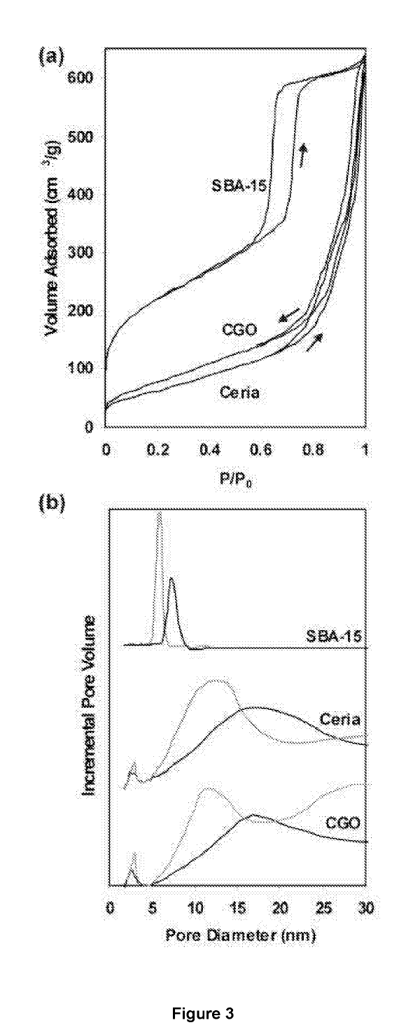

Gas adsorption-desorption isotherms, and the pore size distributions (PSDs) obtained for these, are given in FIG. 3 for the SBA-15 template and the Ceria-S and CGO-S products. The isotherms for all three materials are Type IV with Type H3 hysteresis which is typical of mesoporous materials where capillary condensation occurs in the mesopores. Values for SSA, specific pore volume and pore size obtained from the physisorption experiments are summarised in Table 1. For SBA-15, these relate to several batches of material and were in agreement with the literature. Considering that the densities of ceria and CGO are around 2.72 times those of silica, the SSAs and specific pore volumes of the Ceria-S and CGO-S products indicate that very porous products had been achieved.

The SBA-15 showed narrow peaks in the PSD at 5.9-7.3 nm (determined from the adsorption and desorption branches) indicating a good quality template. The two products each showed a sharp peak at around 2.7 nm and a broader peak centred at around 12 nm for Ceria-S and around 14 nm for CGO-S, confirming that the products were largely mesoporous.

The broad peak for both materials at around 30 nm can be assigned as interparticle porosity, and so not related to the mesopore structure. The peak at around 2.7 nm can be assigned as the pores formed in the product after removal of the walls of the template.

Taking the more reliable value of interpore spacing for SBA-15 (from SAXS) of 9.3 nm and subtracting the SBA-15 pore diameter, 5.9-7.3 nm, one arrives at a value of 2.0-3.4 nm for wall thickness in the template, which is consistent with the size of the small pores detected in the products (2.4-3.0 and 2.5-3.0 nm). This is evidence that templating was successful and that the product had taken on the inverse (or negative) structure of the template.

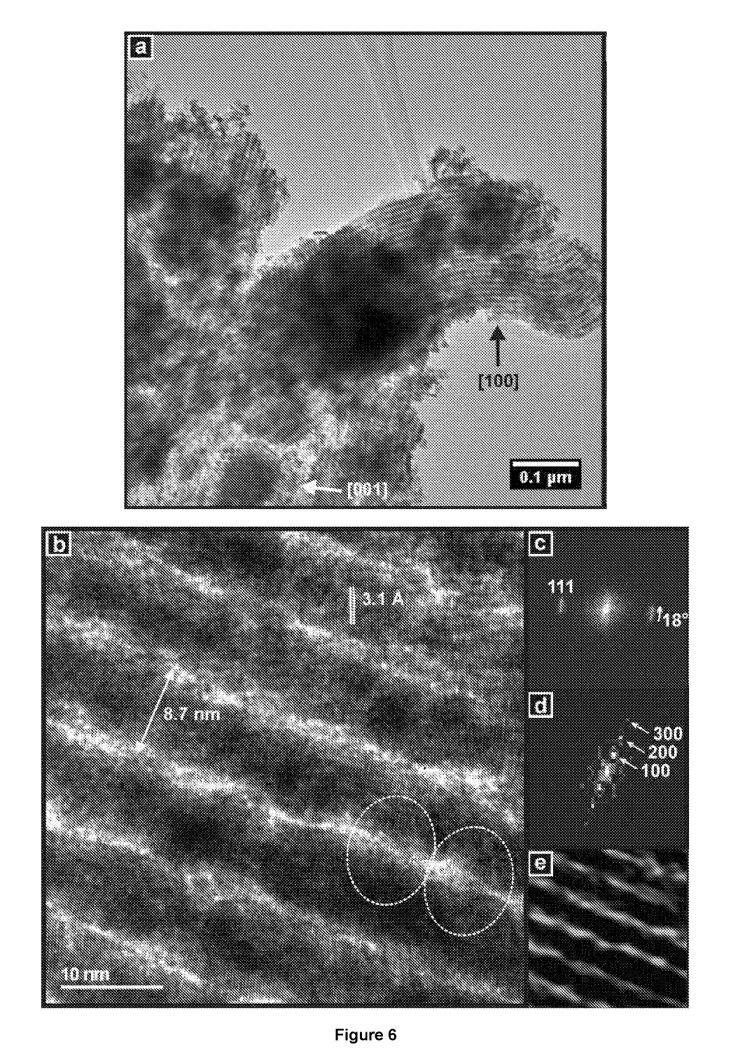

There are three possible explanations for the broad peaks centred on 12 and 14 nm. Firstly, bundles of loose nanorods existing outside the ordered mesopore structure may give rise to a broad peak at around this pore size. Secondly, in the mesopore product structure itself, the edges of the mesopores are accessible as long slots (in the [100] direction in FIG. 6a, for example), unlike in the SBA-15 template. Physisorption through these openings would be expected to give pore sizes above 2.7 nm because of their high aspect ratio. Finally, short missing sections of nanorod in the mesoporous product would leave voids whose diameter would be the sum of two pore and one nanorod diameters, about 14-15 nm (for CGO-S, values from Table 1).

Small Angle Xray Scattering (SAXS)

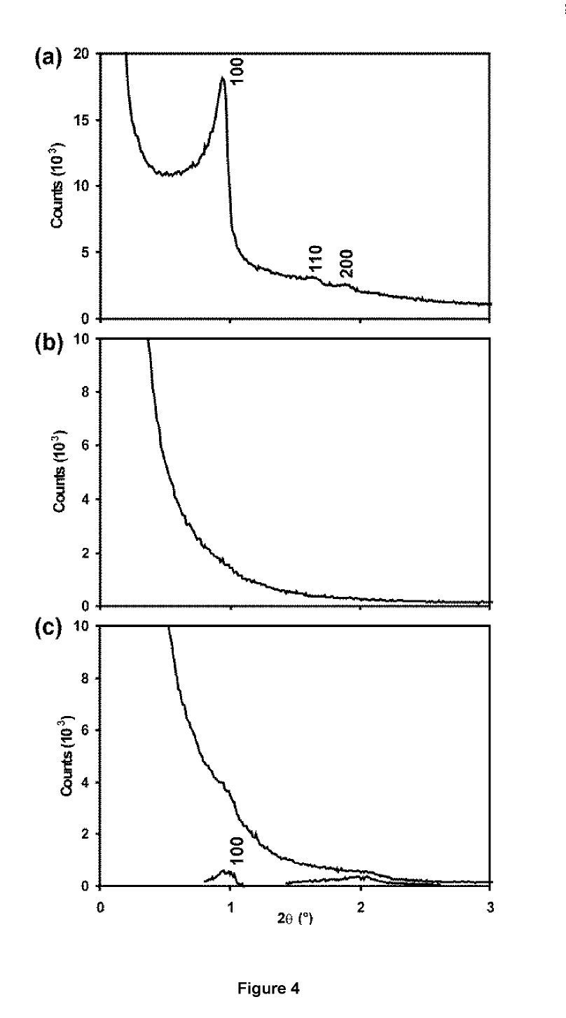

In the SAXS patterns presented in FIG. 4, diffraction peaks for SBA-15 at Miller indices of 100, 110 and 200 of the mesopore structure are clearly visible superimposed as shoulders on the large undiffracted instrumental peak centred at 2θ=0°. This confirms the ordered nature of the mesoporous structure.

For CGO-S small peaks were evident at positions which matched those of the template. These were more evident on subtracting the background (FIG. 4c). The d₁₀₀ spacings of the pore structures are compared in Table 1 for the SBA-related materials. This demonstrates that the CGO-S had been successfully templated by the SBA-15. Although the mesoporous rare earth oxide material has an inverse structure in which voids within the mesoporous template are filled, and the pores are formed where the template material has been removed, the size and symmetry of the repeat unit of the mesoporous structure can be expected to be the same for both the mesoporous rare earth oxide material and the mesoporous template from which it has been formed.

The absence of clear SAXS peaks for Ceria-S is discussed further below.

Electron Microscopy

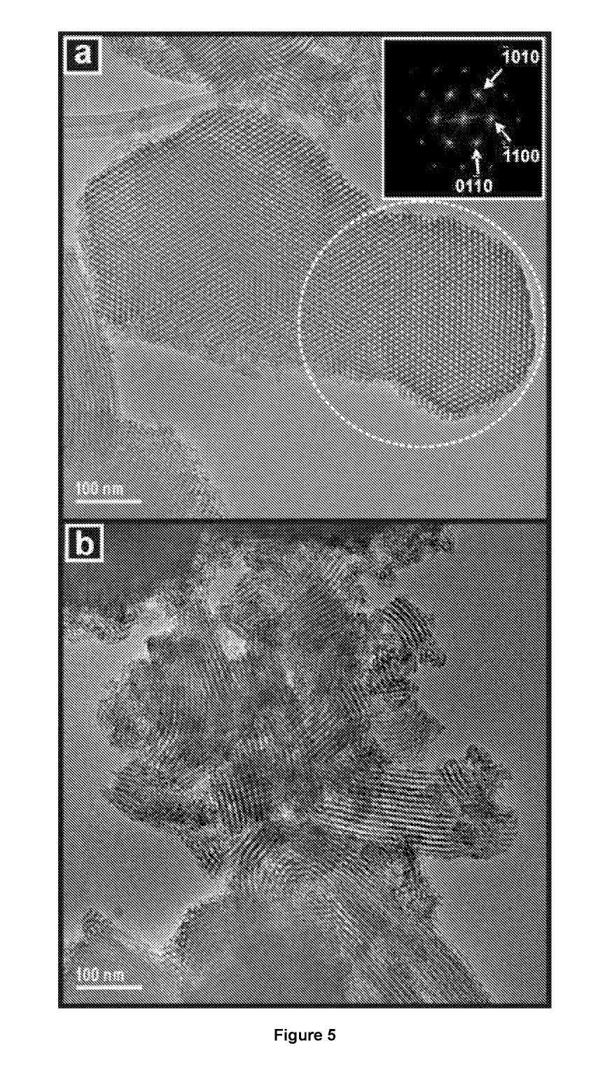

The extensive and widespread ordered pore structure of the SBA-15 template is clearly seen in the images presented in FIG. 5 and by the DDP of the circled area which shows the hexagonal arrangement of mesopores when viewing along the [001] zone axis. In FIG. 5b the pores are viewed along the [100] zone axis and are seen to be gently curved, which is a known characteristic of SBA-15.

This curved structure is replicated in the image of the SBA-15-templated product, Ceria-S, in FIG. 6a. The large agglomeration (˜1 μm) in the image consists largely or entirely of mesoporous particles and there are examples of both the and [001] orientations. It should be kept in mind that some mesoporous particles may not appear in the image, if there is overlap with other particles and/or if their pore structure is not aligned with the electron beam of the TEM. The interpore spacing of 8.9-9.7 nm was measured directly from the images and also from DDPs. This is consistent with the corresponding spacing for the SBA-15 mesoporous template, the value of which was obtained by TEM and SAXS (see Table 1).

The high resolution image in FIG. 6b shows several important features. First, the imaged area of the sample consists of cylindrical nanorod structures of uniform diameter separated by narrower mesopores. This is the inverse of the SBA-15 structure, and again demonstrates that the pores of the template have been impregnated with material and that the walls of the mesoporous silica template have subsequently been removed to leave mesopores between the nanorods.

Importantly, the two circled regions of FIG. 6b highlight two examples of nanoscale bridges which interconnect the nanorods and so hold the structure together. This is indicative of complete or substantially complete impregnation of the mesoporous template during synthesis. These bridges are thought to improve mechanical and/or thermal stability of the mesoporous rare earth oxide materials.

The extensive impregnation which has been possible in use of the method of the present invention may also give rise to larger mesoporous crystallites. Indeed, the area imaged is essentially a single crystal of mesoporous rare earth oxide material. The crystal lattice planes are visible in the image and are seen to remain parallel across the structure and between nanorods. Therefore, the bridges between nanorods must play an important role in achieving this long-range alignment of the lattice during crystallisation and grain growth.

The DDP in FIG. 6c confirms the single crystalline nature of the imaged sample as it contains only one pair of spots which are consistent with the 111 planes of the ceria lattice. However, these spots are in fact extended into short arcs—of 18° in this case—which indicates that the lattice planes change direction gradually across the image while remaining essentially parallel (as is seen on careful study of the images themselves). This strained crystal structure is an interesting and general feature of the mesoporous products prepared in this study.

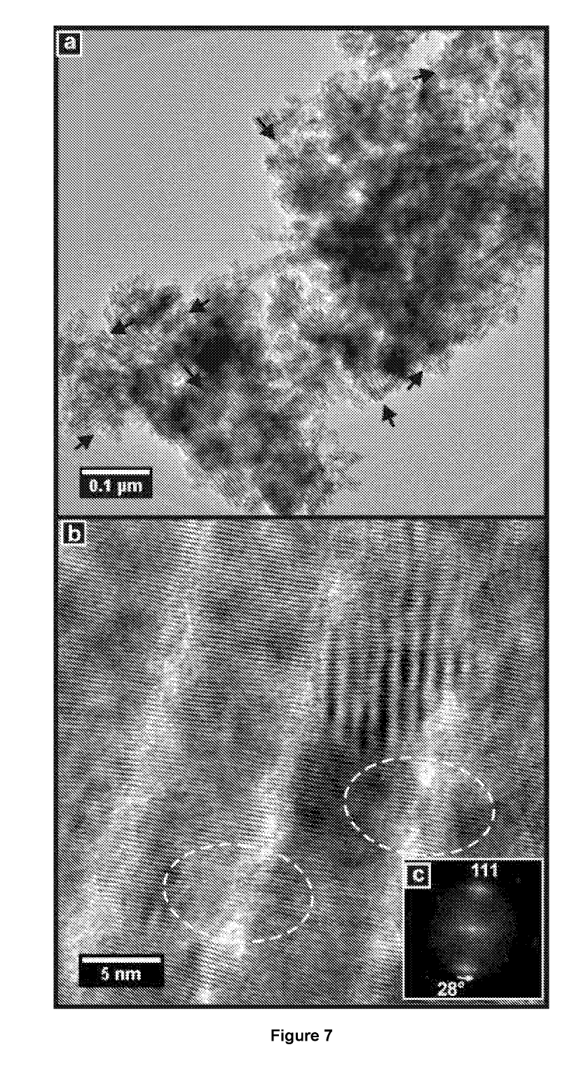

FIG. 7 shows very similar features for the CGO-S material. The yield of mesoporous material was very high and was observed throughout the sample. Some of the particles which have their pore structures aligned with the TEM beam are indicated in the image. Interpore spacings obtained from images and DDPs agreed very well with SAXS data for this sample and were consistent with the interpore spacings obtained for SBA-15 (Table 1). The parallel nanorods—separated by narrow pores and interconnected by small bridges—are seen in the high resolution image in FIG. 7b. The long-range alignment of the crystal lattice, between nanorods and across the bridges, is also evident. In the DDP of the image in FIG. 7c the spots are consistent with the 111 interplanar distance of the CGO lattice. The continuous angular variation over 28° in the position of the 111 spot indicates again—as was seen for Ceria-S—a gentle change of direction of the lattice planes across the sample.

The TEM images show some variation in the width of the nanorods which define the mesopores of these materials. The resulting small variations in interpore distance and pore dimensions observed for Ceria-S may have caused scattering and line-broadening in the SAXS experiment and so may explain the absence of peaks for Ceria-S. This hypothesis is supported by a comparison with data obtained from the CGO-S material, in which the variations were generally smaller. The CGO-S material did give rise to peaks in the SAXS pattern. Doping ceria with Gd is known to aid sintering in CGO and so this may have aided the filling of the pores of the template during crystallisation and grain growth of the CGO, resulting in the slightly higher pore volume observed, and more geometrically well-defined nanorods, than in Ceria-S.

Structures of KIT-6, Ceria-K and CGO-K

Gas Physisorption

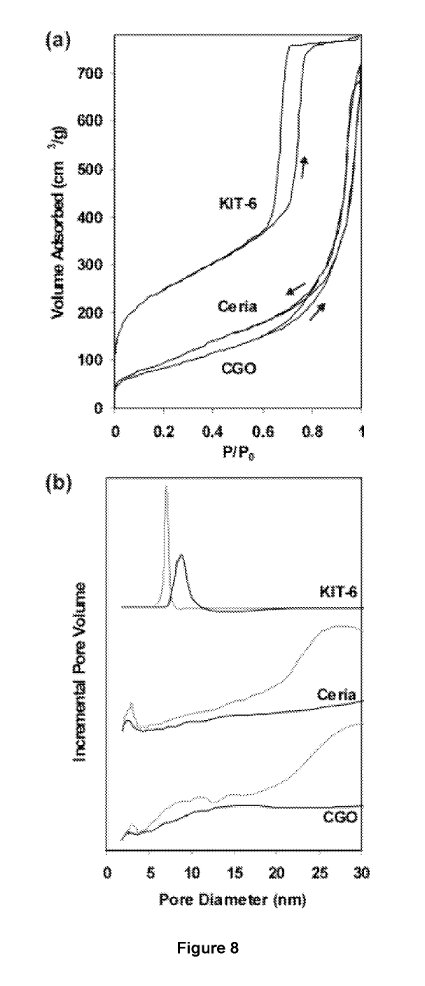

The gas adsorption-desorption isotherms and the PSD plots derived from them are presented for KIT-6—and for the Ceria-K and CGO-K made using it—in FIG. 8. The isotherms for all three materials are again Type IV with Type H3 hysteresis, which is typical of mesoporous materials. SSA and pore volume values were obtained from the physisorption data and are displayed in Table 1.

For KIT-6, these values refer to a number of batches of material. As for the SBA-16, SSAs and pore volumes were very high, as expected from the literature. For the two products, SSAs and pore volumes were all significantly higher than for the corresponding materials prepared using the SBA-15 template. This may be at least partly because of SSA and pore volume being higher for KIT-6 than for SBA-15. However, it may also be a consequence of KIT-6 having a three-dimensional, rather than a one-dimensional, pore structure like SBA-15, and so facilitating precursor impregnation.

The PSD plots show KIT-6 to have a single narrow peak around 7 nm. Ceria-K and CGO-K showed sharp peaks around 2.5 nm then a poorly-defined broad feature centred on about 8 nm (clearer for CGO-K) and finally a broad peak around 25-30 nm, which can be assigned as interparticle porosity.

As above, the peaks at around 2.5 nm verify the presence of mesopores in the mesoporous rare earth oxide products, which remain after the mesoporous template has been removed.

The poorly-defined peaks around 8 nm can be explained—as above—by interparticle porosity, the effect of short missing sections of nanorod giving rise to relatively wide pores, or to adsorption through “letter-box” shaped pores/openings in the structure.

It should be noted that for all products, the mesoporous structures of the resulting rare earth oxides are the negative of the mesoporous template. Accordingly, the pores are not simply spherical or cylindrical pores, but rather are complex shapes which surround the rare earth oxide nanorods and are interconnected between themselves. Hence, interpretation of the physisorption results in terms of precise pore shape and dimensions, using standard models (which assume simple pore shapes) can be difficult for these materials.

SAXS

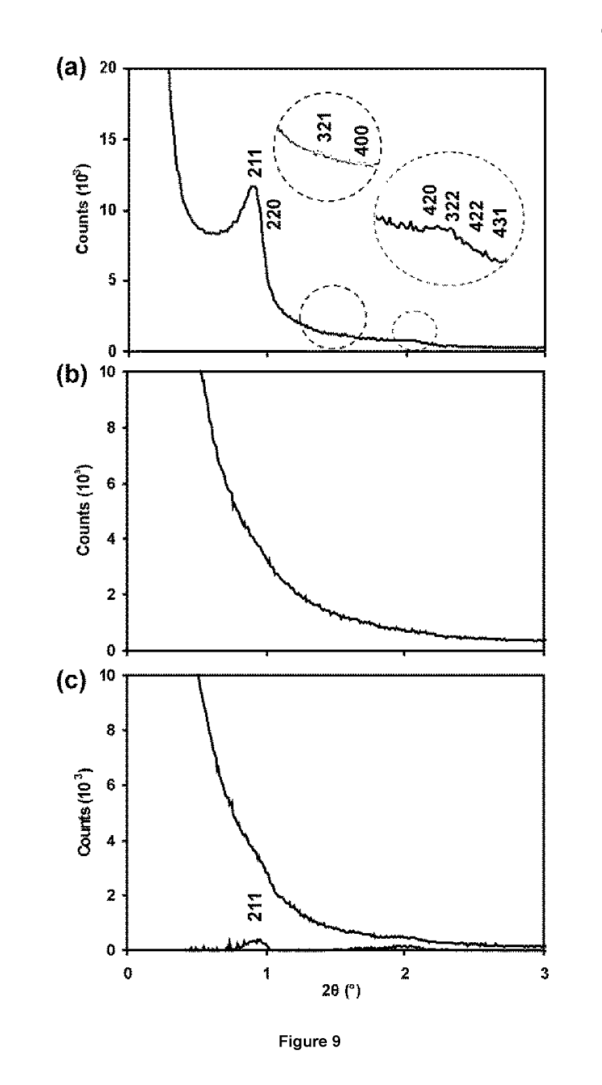

In FIG. 9, the SAXS pattern for KIT-6 shows one very clear peak corresponding to the 211 planes of the pore structure, a shoulder for 220 and broad features for two sets of higher index planes. Again, the ceria product gave rise to a smooth curve with no resolvable peaks while the CGO-K exhibited the 211 peak quite clearly along with a broad feature around 28=2° (which, as above, can be more clearly seen after background subtraction). The pore spacing value, d₂₂₀, for the mesoporous rare earth oxide product CGO-K is seen to be 10% lower than for the template, KIT-6, in Table 1. This indicates some contraction of the mesopore structure of the product during calcination or template removal.

Electron Microscopy

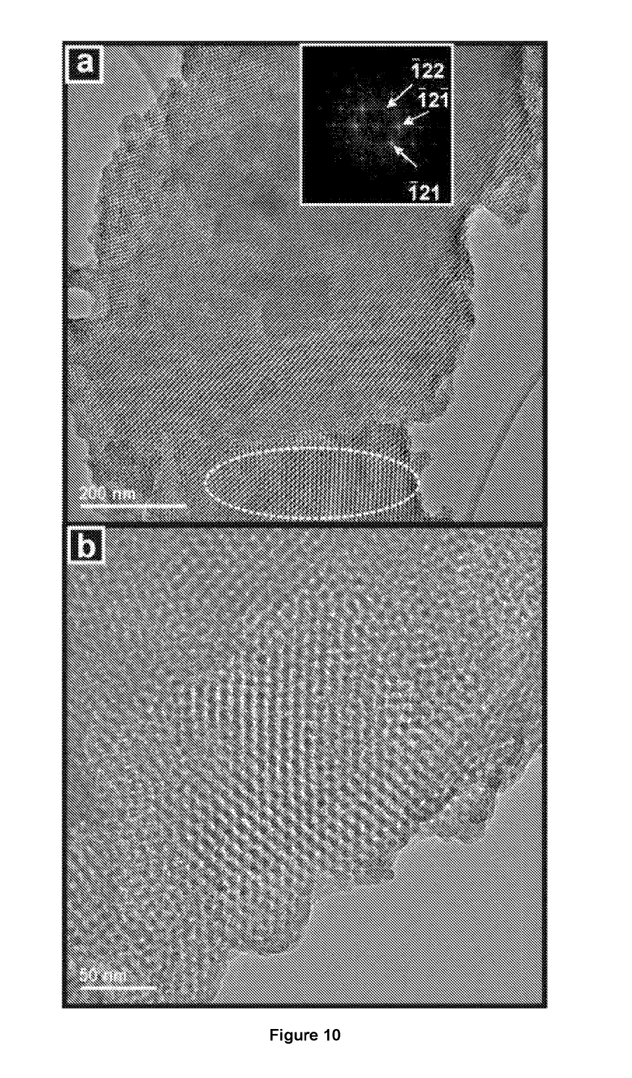

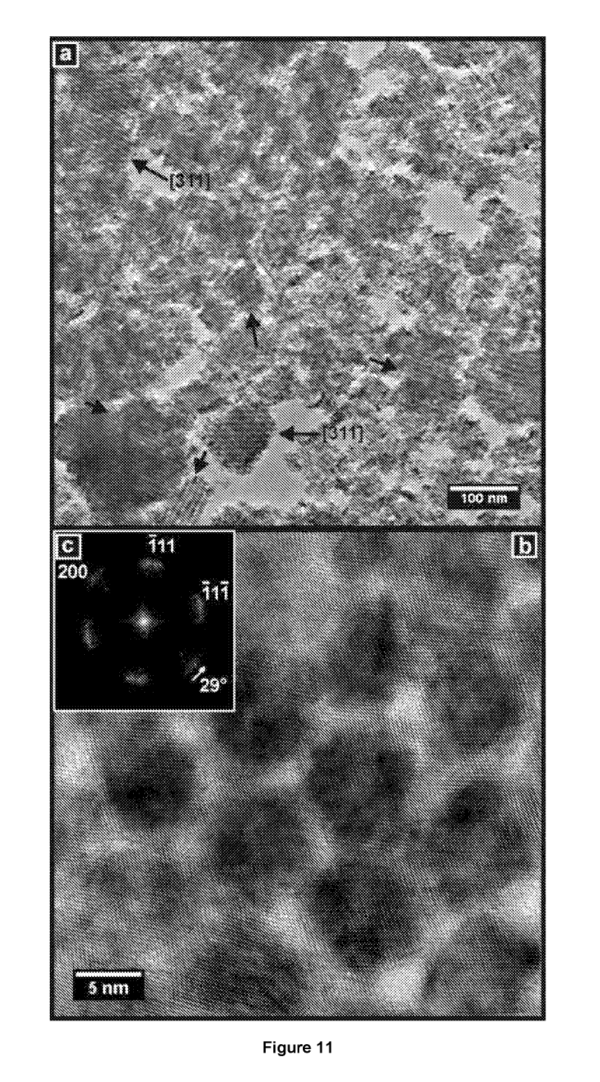

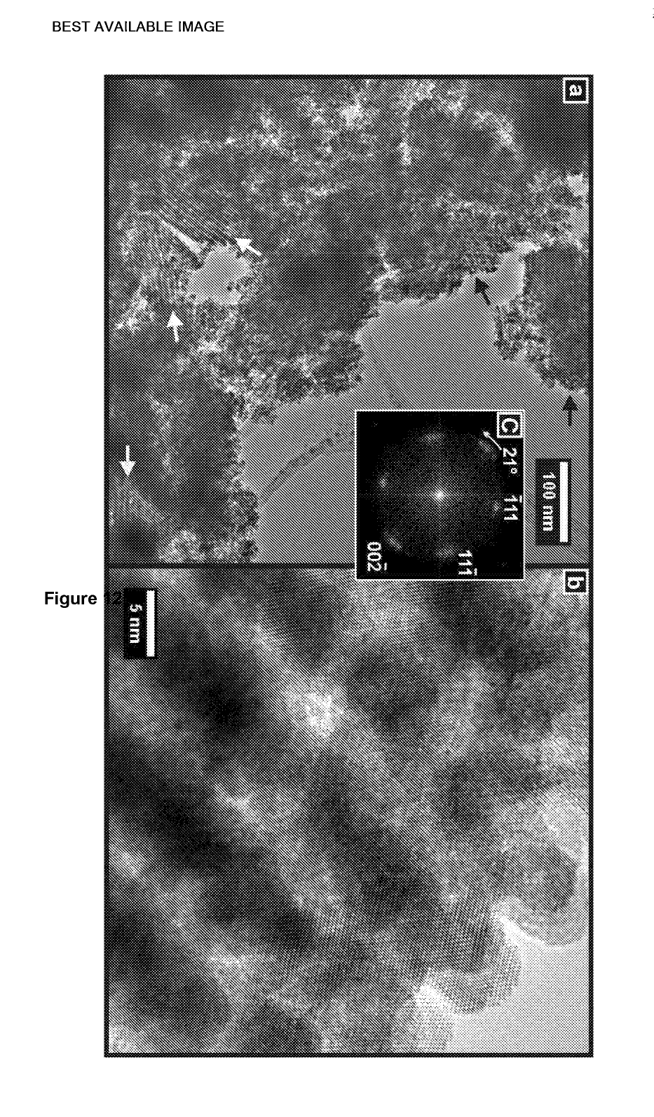

TEM images of KIT-6 showed large particles, some larger than 1 μm, that contained arrays of ordered mesopores across their entirety. FIG. 10a shows such a particle which may be an agglomeration of several smaller ones. The pores are seen to be uniform along their length and parallel to each other. The inset DDP was taken from the circled area of the image and shows spots which can be indexed to the [211] zone axis of the cubic KIT-6 pore structure. FIG. 10b is a higher resolution image showing a region of another particle. The orientation of the pores is seen to change across the image, indicating the presence of microdomains in the pore structure.

TEM images of the Ceria-K and CGO-K products obtained using the KIT-6 template are presented in FIGS. 11 and 12.

The image in FIG. 11a confirms that a very high yield of mesoporous particles was obtained and examples are indicated in the image. Two of these have pore structures that are well enough aligned to the TEM beam to allow them to be indexed, and they are both observed down the [311] zone axis of the (inverse/negative) KIT-6 pore structure.

FIG. 11b shows a very clear high resolution image of the mesoporous structure of Ceria-K. The concentrations of ceria material between the pores are observed as dark, roughly circular features. These are not simple nanorods as in SBA-15, since the direction of the wormholes in the KIT-6 template changes through the structure. They are better considered to be caused by the overlap—in the direction normal to the plane of the image—of nodes or junctions between intertwined (non-linear) nanorods in the inverse KIT-6 structure, giving rise to dark contrast in the image.

These features are clearly ordered in a hexagonal arrangement with angles between planes measured at 60°. This indicates that the pore structure is viewed here along its [111] zone axis. In addition, the planes of the crystal lattice are also clearly seen.

The DDP in FIG. 11c is taken from the whole image and shows a complete pattern which can be indexed to the Fluorite structure of ceria viewed along the direction. Importantly, this DDP demonstrates that the crystal structure of Ceria-K was aligned across the material, it being essentially a porous single crystal, and that the diffraction spots are in fact converted to short arcs by the gentle variation in direction of the lattice planes across the sample. This same phenomenon was discussed above for Ceria-S and CGO-S.

TEM images showed that the CGO-K material had also been successfully prepared with widespread mesoporous structure. This is seen in FIG. 12a where particles with aligned pore structures are identified. At high resolution, the ordered pore structure is seen to consist of essentially single crystalline CGO. FIG. 12b shows such a region of the sample. The crystal lattice planes are clearly visible and this image was used to generate the DDP in FIG. 12c which shows a complete diffraction pattern consistent with CGO viewed along the [110] zone axis. Again, the bending of the lattice planes gives rise to the arcs seen in the DDP.

Behaviour and Properties of Mesoporous Rare Earth Oxide Materials

Reduction Behaviour

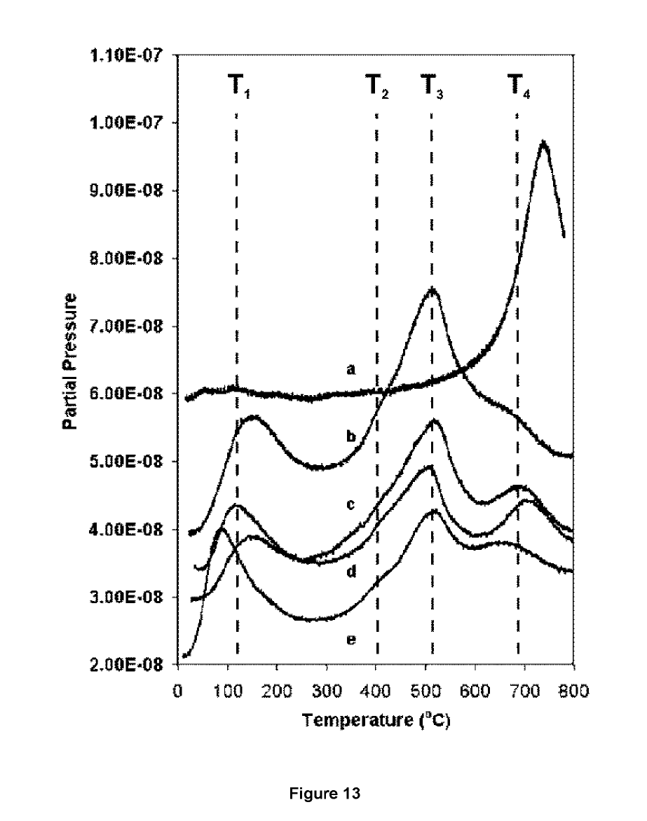

TPR spectra were obtained in flowing dilute Hydrogen by recording the water signal (m/q=18) as a function of temperature for the Ceria-X reference material and for all four products. The five spectra are presented together in FIG. 13. The peaks are grouped and labelled as T₁ to T₄, in order of increasing temperature. The reference material exhibited a very small peak at around 100° C. (T₁) which can be attributed to the desorption of physisorbed water from the ceria surface. The only other feature is a very large peak at 745° C. (T₄) which is attributed to reduction of relatively unreactive sample oxygen species by the hydrogen, usually assigned as bulk or lattice oxygen. Comparing first this spectrum with those of the four mesoporous products taken together, a number of important and general differences are seen.

The most important change is the occurrence of one large new peak at about 520° C. (T₃). A second smaller new peak (T₂) also appears at around 430° C. as a shoulder on T₃. Because of the size of the (T₂+T₃) feature and its appearance at intermediate temperatures, it is attributed to the reduction of a large amount of reactive oxygen in the mesoporous materials. Furthermore, the fact that the T₄ peaks are much smaller than for the reference sample indicates that the amount of relatively unreactive oxygen is much smaller. Together, these changes mark a significant shift towards active, easily available oxygen in the mesoporous samples.

The T₁ peaks are broader and much larger than for the Ceria-X reference. These properties can be explained by the combination of up to three effects. (1) the high SSAs of the mesoporous materials allow them to accommodate a large amount of surface water and the mesopore network may delay its desorption in the transient TPR experiment to above 100° C. (2) Ceria-based materials are known to be hygroscopic which would increase further the amount of water on the surfaces and may delay it's desorption to temperatures above 100° C. (3) The presence of highly reactive peroxide and superoxide species on the surface of high surface area ceria has been reported. The reduction of these at around 150° C. may contribute to the T₁ peaks in the mesoporous materials.

TABLE 2
Positions of peaks in TPR spectra (° C.)

| | T₁ | T₂ | T₃ | T₄ |
|---|---|---|---|---|
| Ceria-X | ~100 | — | — | 745 |
| Ceria-S | 125 | — | 514 | 712 |
| Ceria-K | 154 | — | 523 | 696 |
| CGO-S | 94 | 435 | 525 | 664 |
| CGO-K | 156 | 450 | 519 | 665 |

The TPR peak positions for all samples given in Table 2 allow a comparison of these values for all of the materials tested. Peak T₁ was discussed above and peak T₂ is a minor shoulder whose position is hard to determine accurately. T₃ shows little variation which suggests that the corresponding reduction reactions are not sensitive to composition or to the mesopore structure.

T₄ is lower for all mesoporous materials than for Ceria-X, implying that the pore structure facilitates the reduction of the bulk material. In addition, oxygen ion diffusion/conductivity in CGO is known to be greater than for undoped ceria, which is likely to favour the reduction kinetics in CGO. It is relevant, then, that T₄ is lower for CGO samples than for the corresponding ceria samples.

The marked increase in reducibility of all four mesoporous products compared to a high SSA ceria is of great interest in relation to their applications as reduction and/or oxidation catalysts.

Photovoltaic (PV) Studies

PV studies were conducted to investigate ordered mesoporous ceria as a potential bulk heterojunction material for dye-sensitised solar cells.

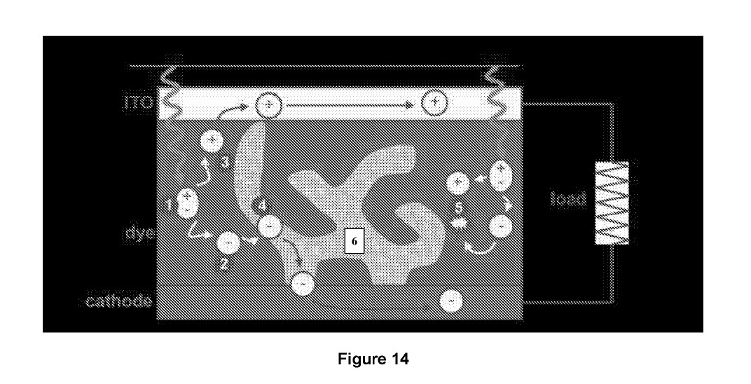

FIG. 14 shows a schematic diagram of a dye-sensitised solar cell. Dye-sensitised solar cells are based on an organic semiconductor dye that is sandwiched between two conducting electrodes, at least one of which is transparent to light (typically indium tin oxide; ITO). The dye absorbs photons (suggested by the zig-zag lines passing through the ITO layer). This results in the formation of excitons 1. Excitons are bound states of energy—an electron and an electron hole—that are a means of transporting energy without transporting charge. To create a current the exciton binding energy must be overcome to separate the exciton into its constituent charges. The electron 2 and the electron hole 3 must then be captured in a process called exciton quenching within the exciton lifetime before recombination occurs. Recombination is shown schematically at 5. If recombination occurs then the charge will be lost and the energy cannot contribute to the cell potential, decreasing the efficiency of the solar cell. The excitons travel through the polymer by a random walk process, and in a typical lifetime they will recombine within 20 nm. As it is difficult to synthesise a cell with a 20 nm thick dye layer that can absorb all of the incident solar radiation, a porous inorganic semiconductor (commonly TiO₂) is often placed in the cell which, when blended with the dye, is called a bulk heterojunction 6. The purpose of the bulk heterojunction is to accept the electrons from the dye and transport them to the cathode, as shown schematically at 4. An electron reaches the bulk heterojunction 6 and is transported towards the cathode.

The PV studies were was conducted using Ceria-K. Two samples of Ceria-K were used to construct a dye-sensitised solar cell, comprising a bulk heterojunction formed from the mesoporous ceria and the dye, as described generally above.

One sample was reduced in 5% H₂/Ar at 450° C. for 1 h (Ceria, reduced) before the PV studies to increase the concentration of cerium(III) ([Ce³⁺]), the other sample examined was untreated (Ceria, unreduced).

Two parameters were examined: the photoluminescence quenching half-life, τ, and the quenching efficiency, which measures the efficiency of the material to separate the exciton charges to prevent exciton annihilation. Photoluminescence (PL) spectroscopy is an effective technique for determining the quenching efficiency of excitons in a dye-sensitised solar cell. The sample is excited with a laser pulse, at a known frequency, creating excitons; electron-“hole” pairs. Some exitons recombine causing photoemission some time after the initial excitation (PL). These emitted photons are detected as a function of time, using a specially-designed detector with a temporal resolution of about 1 ps. Comparison of the energies of the laser pulse and the PL emission provides the quenching efficiency. An efficient bulk heterojunction would allow a large proportion of electrons and holes to be collected (so generating useful electrical power) before recombination, so reducing the amount of PL. Analysis of the decay of emitted PL light intensity with time gives the half-life, τ, of the PL of the material.

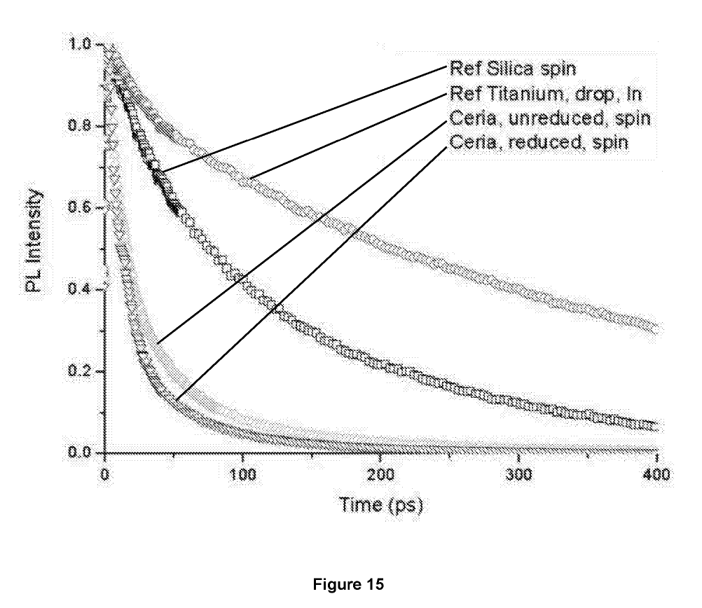

Preliminary photoluminescence experiments showed that Ceria-K quenched the excitons produced in the organic dye rapidly (FIG. 15) and much faster than titania, which is widely considered for this application (Macaira et al, Renew. Sustain. Energy Rev. 27 334 (2013)). Results are summarised in Table 3. This meant that, compared to reference materials, the excitons were easily extracted from the dye before recombination occurred. The reduced ceria quenched the excitons faster than the standard (unreduced) Ceria-K sample. This may be due to the increased [Ce³⁺] which would be expected to lead to an increased electronic conductivity. The quenching efficiency of both materials was high (90-93%), however.

TABLE 3

| | Quenching half-life | Quenching |
|---|---|---|
| Sample | τ (ps) | efficiency (%) |
| Reference silica | 334 | — |
| Reference titania | 126 | — |
| Ceria-K | 34 | 90 |
| Reduced Ceria-K | 23 | 93 |

The PL experiment showed that the ordered mesoporous matrix had a great affinity for exciton quenching even though its properties had not been rigorously developed for solar cells.

As effective exciton quenching occurs if the excitons can be removed from the dye before they have time to recombine, a small distance between the dye and semiconductor of 5-20 nm is ideal. In this case, the mesoporous ceria is the semiconductor and has a half-pore width of around 1.5-2 nm. This means that these materials have the potential to increase dye-sensitised solar cell efficiencies.

Moreover, by selection of the mesoporous template used to form the materials, mesopore morphology may be tailored for the particular application, and so the material could be designed for use with a particular dye, for example. Alternatively or in addition, the oxide composition itself may be matched for a particular application, for example to optimise electron transfer from the dye.

As discussed above, the method provides for preparation of mesoporous rare earth oxide materials with greater order in the pore walls, so decreasing grain boundary resistances and improving the electrical properties, to the benefit of these photovoltaic and electrode applications.

To improve the organic dye impregnation (itself a viscous liquid when in solution because of its high Mr), and the contact with the semiconductor, “vacuum impregnation” could be used again.

The inventors note that ceria has an additional benefit that it absorbs ultra-violet (UV) radiation, and would therefore provide additional protection for the organic dye against UV degradation.

Thermal Resistance Studies

Materials for use in applications such as heterogeneous catalysis and fuel cells are required to be thermally stable at their operating temperatures. CGO-K was studied by heating the material to 1000° C. inside a TEM in vacuo over a period of 4 h.

CGO-S was studied by calcining the material to 500° C. and 650° C. for 48 h and 72 h, respectively, in air. These samples were then characterised using TEM and nitrogen physisorption.

In-Situ TEM Heating of CGO-K

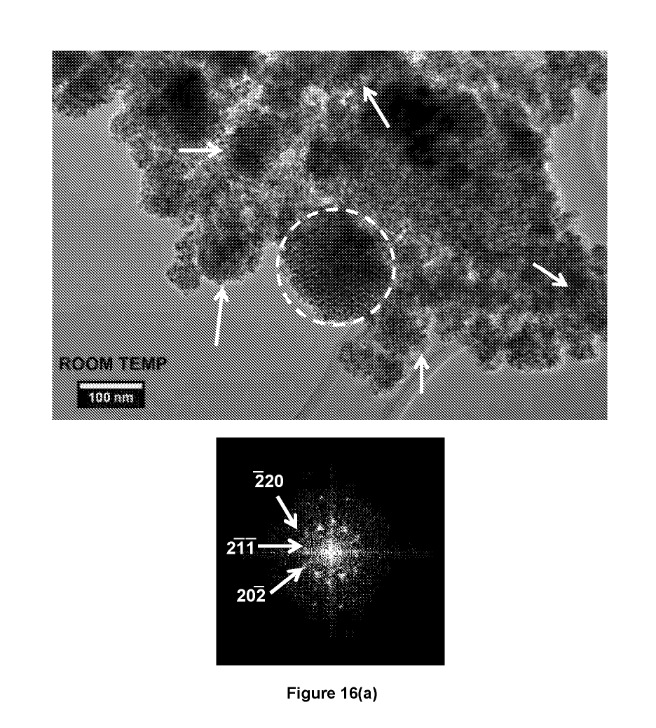

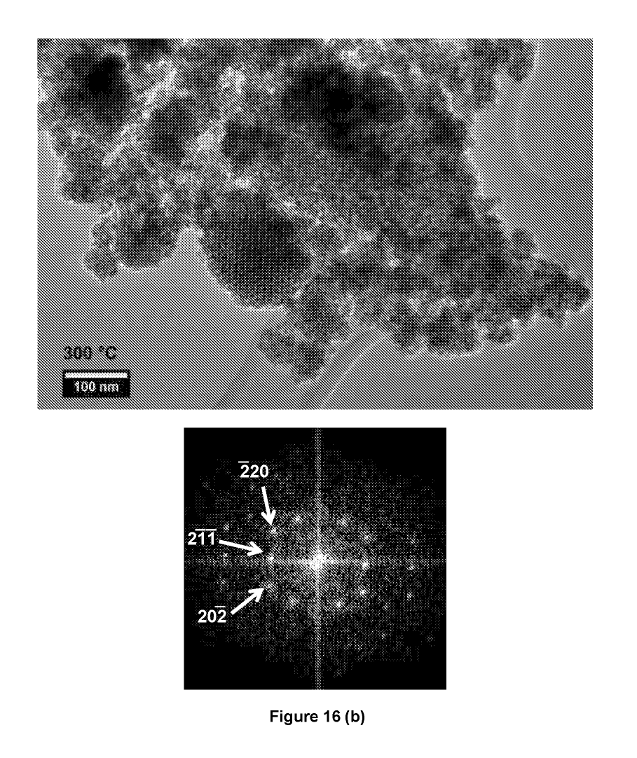

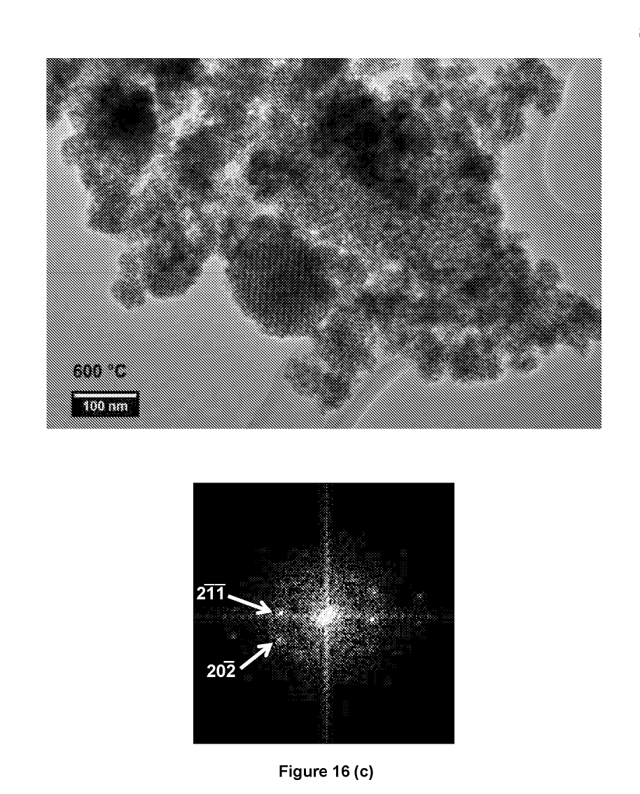

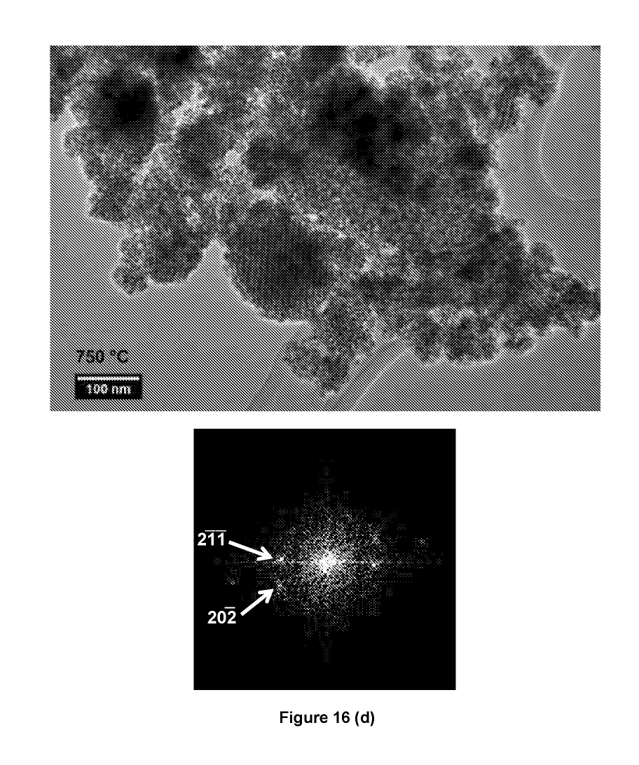

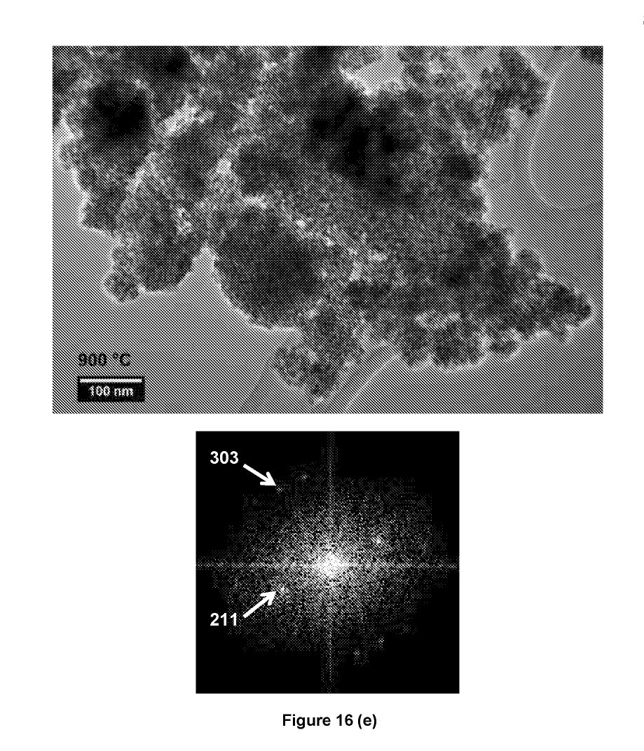

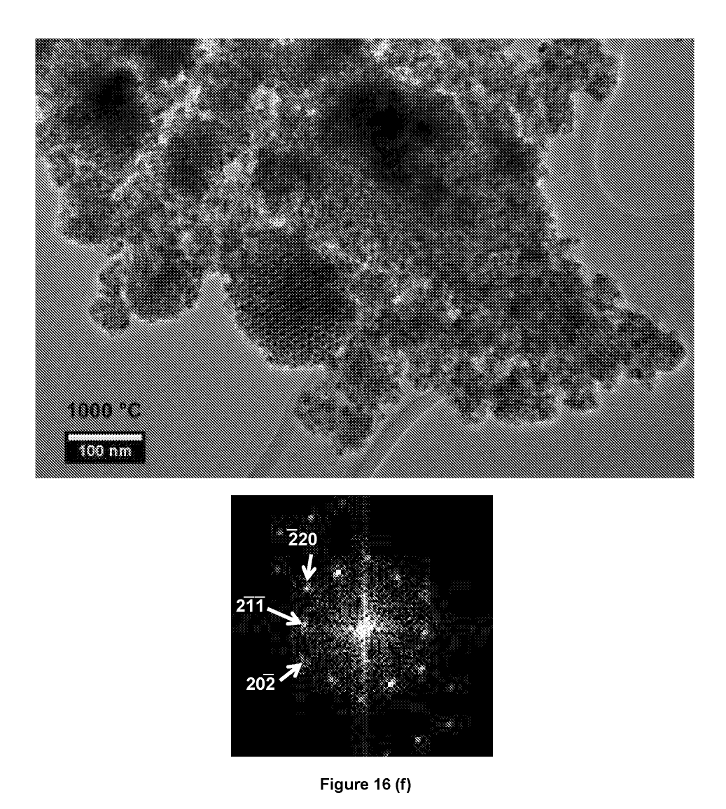

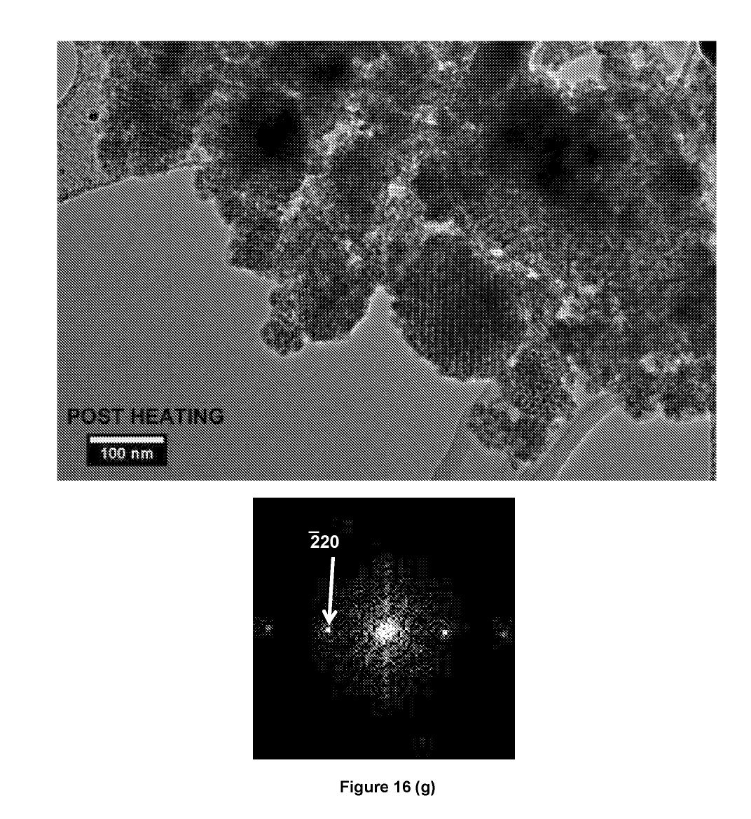

The results for the in-situ heating experiments are presented in FIG. 16. A large agglomerate was selected for observation based on its composition of ordered mesporous particles and nanoparticulate material. The sample was heated to 1000° C. inside the TEM over a period of about 4 h. After a short period at 1000° C. the carbon grid failed.

FIG. 16 presents an area of the agglomeration which features a 150×150 nm particle, presented in the [111] zone axis of the mesopore structure, that was selected for observation during the experiment (circled in FIG. 16(a)).

Surrounding this particle were other mesoporous particles as indicated in the image. Upon heating, it is shown that either different mesoporous particles became visible or the particles visible at room temperature rotated to present a different pore axis. The primary feature, of which DDPs were taken at each temperature, can be seen to pass from the [111] zone axis in FIG. 16(a) into a misaligned [111] orientation in FIG. 16(b). In FIGS. 16(c) and (d), all but two of the primary spots disappeared due to this misalignment. In FIG. 16(e), new spots appeared that were consistent with the (303) reflection. In FIG. 16(f), the particle is again in the [111] orientation.

It was confirmed that the orientation of particles within the sample had not altered in FIG. 16(f), by taking reference points in the image and comparing them to the previous images in the series. The lattice constants extracted from the DDP reflections did not decrease, within experimental variation, when increasing the temperature up to 1000° C.

The ordered mesoporous materials showed high thermal stability at temperatures coinciding with the lower edge of the reduction peak (determined by TP studies to be approximately 500° C.), at which these materials could be used for redox applications such as in catalysis and SOFCs. When heated above this temperature for prolonged periods there was some evidence of sintering. However, heating in-situ in the TEM showed that over periods of ca. 4 h the materials could be heated to temperatures of up to 1000° C., and cooled down again to room temperature, without loss of structure.

It is possible that the mesoporous crystals had already grown sufficiently large that their equilibrium melting temperature made them stable at intermediate temperatures.

In contrast, the nanoparticles also present in the samples have a lower equilibrium melting temperature.

There is also some evidence from scattering experiments that the non-mesoporous by-products have been more affected by the thermal treatment than the mesoporous rare earth oxide materials.

It may be that the sintering of the by-products would cause the mass of the mesoporous crystals to rise (by Otswald ripening) and consequently equilibrium melting temperature of the sample.

Unlike all of the mesoporous ceria materials previously reported, ordered mesoporous CGO studied here (CGO-S) showed a plateau in measured SSA (see Thermal Stability below) up to approximately 500° C., across which the specific surface area decreased only by a small amount.

Thermal Stability

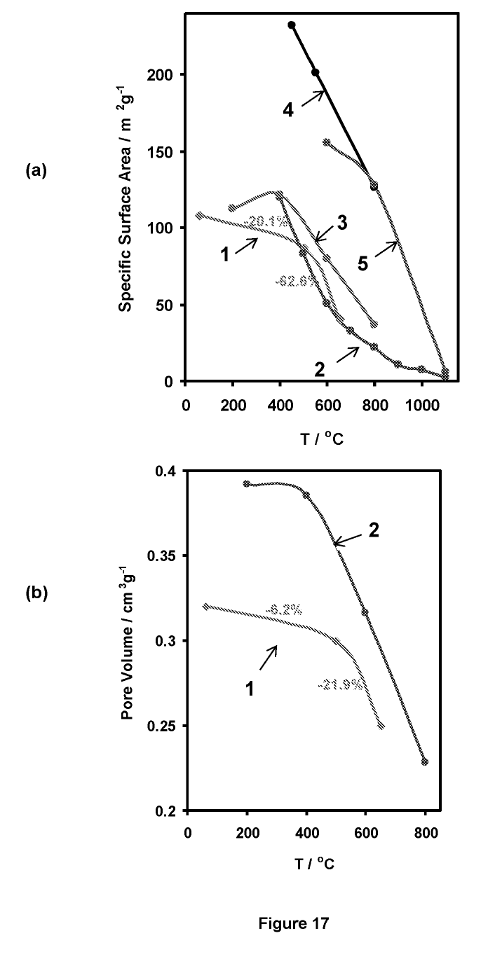

Previous literature reports on the thermal stability of mesoporous ceria have shown a steady decrease in the specific surface area with increasing temperature (FIG. 17(a)).

Note that the cause for the increase in the specific surface area in the report from Wang et al, Chemistry of Materials 14 (2002) 4676 was due to incomplete removal of the template at 200° C. At 400° C. the template had been fully removed causing the pores to become unblocked, increasing the specific surface area.

Unlike all of the mesoporous ceria materials previously reported, ordered mesoporous CGO (sample CGO-S described above) appeared to have a plateau up to approximately 500° C. where the specific surface area decreased only a small amount.

Comparing the pore volume data for CGO-S with the ceria synthesised by Lundberg et al., Microporous and Mesoporous Materials 54 (2002) 97 using P123 in cooperative self-assembly (FIG. 17(b)) it can be seen that initially there is much less pore volume lost in CGO-S. It should also be noted that CGO—S—V₂ was heated for between 12-24 times longer than the other samples presented in FIG. 17.

These initial physisorption results are consistent with the proposed annealing/sintering mechanism of the pore walls, described herein. The remaining samples, with high concentrations of nanoparticles, were more affected by lower temperatures than the ordered mesoporous material prepared in accordance with the invention, and the ordered mesoporous material appears to be capable of maintaining a high pore volume even after being subjected to high temperatures for extended periods of time.

### CONCLUSIONS

In summary therefore, four mesoporous rare earth oxide materials, prepared in accordance with the present invention have been characterised in detail using powder XRD, TEM, gas physisorption, SAXS and TPR studies.

These data suggest that ordered mesoporous materials have been produced, which represent a significant improvement on established methods for preparing such materials, such as incipient wetness impregnation, as discussed above. All of the compositions and templates examined have been produced on multiple occasions at high yields, showing that the methods described herein are reproducible (Table 1).

The pore volumes of the products were determined to be high and the pore size and spacings related well to the templates from which the materials were synthesised. TEM studies confirmed that the samples had a 3D structure, this being the negative of the original template.

The materials were not only produced in high yields and high yields of mesoporous material, but also displayed relatively large regions of single crystal morphology within the pore walls.

The dimensions of the mesopore structures were successfully obtained from TEM images.

All of the mesoporous materials prepared showed dramatically increased reducibility in TPR experiments compared to a high SSA nanoparticulate ceria reference. This is very promising for their potential applications in oxidation catalysts and in SOFC components.

The thermal stability of the mesoporous rare earth oxide materials has also been demonstrated.

The photoluminescence behaviour of these materials is also promising in terms of their photovoltaic applications.

1. A method of making a mesoporous rare earth oxide material, the method comprising;
at a reduced pressure, contacting a mesoporous template with a precursor solution that comprises a rare earth metal salt or neutral complex of a rare earth metal, so as to impregnate the mesoporous template;
calcining the impregnated mesoporous template to form a rare earth oxide material in situ; and
removing the mesoporous template from the calcined material.

2. A method according to claim 1, comprising contacting the mesoporous template with a non-aqueous precursor solution so as to impregnate the mesoporous template

3. A method according to claim 2, wherein the precursor solution comprises ethanol as a solvent.

4. A method according to any preceding claim, wherein the precursor solution comprises cerium.

5. A method according to any preceding claim, wherein the precursor solution is a saturated solution, optionally comprising more than 20 wt % of precursor salt.

6. A method according to any preceding claim, comprising calcining at more than one temperature.

7. A method according to claim 6, comprising calcination at a first temperature for a first period of time and at a higher second temperature for a second period of time.

8. A method according to any preceding claim, comprising chemically removing the mesoporous template, by treating with a chemical capable of eroding or digesting the template.

9. A method according to claim 8, wherein the mesoporous template is a silicate material, the method comprising treatment with aqueous alkali metal hydroxide at room temperature.

10. A method according to claim 9, wherein the aqueous alkali metal hydroxide is NaOH(aq) and has a concentration of between around 1-3 M.

11. A method according to any preceding claim, wherein the method comprises making a mixed metal oxide material, comprising atoms/ion of a rare earth metal and one or more further metals, using a precursor solution comprising a mixture of a rare earth metal salt and/or neutral metal complex of the rare earth and one or more further metal salts and/or neutral metal complexes of the further metals, in solution.

12. A method according to any preceding claim, comprising exposing the mesoporous template to the reduced pressure and subsequently contacting the precursor solution therewith.

13. A method according to any preceding claim, wherein the reduced pressure is between around 10⁻²-10⁻¹¹ atm, or 10⁻⁵-10⁻⁸ atm.

14. A method according to any preceding claim, wherein the pressure is increased whilst the mesoporous template and the precursor solution are in contact, subsequent to contacting the mesoporous template with the precursor solution at a reduced pressure.

15. A method according to any preceding claim, comprising drying the impregnated mesoporous template, to remove a portion or substantially all of the solvent, by gently heating at a temperature between around 75-125° C.

16. A method according to any preceding claim, comprising method may comprise repeating one or more, or a sequence of steps.

17. A method according to claim 16, comprising contacting the mesoporous template with a precursor solution at a reduced pressure and, optionally, washing and/or drying the impregnated mesoporous template, on more than one occasion.

18. A method according to claim 16 or 17, comprising repeating a treatment to remove the mesoporous template.

19. A method according to any one of claims 16-18, comprising calcining the impregnated mesoporous template on more than one occasion.

20. A method according to claim 19, wherein calcination is conducted between successive impregnation steps.

21. A mesoporous rare earth oxide material obtained or obtainable by a method in accordance with any preceding claim.

22. A mesoporous rare earth oxide material wherein the mesopores are defined by crystalline rare earth metal oxide material and/or aligned crystallites of rare earth oxide material.

23. A mesoporous rare earth oxide material according to claim 22, wherein the order is evident as high angle reflections in powder XRD patterns taken from the material; and
peaks in small angle X-ray scattering data and/or digital diffraction patterns obtained from regions of TEM images.

24. A mesoporous rare earth oxide material, characterised by one or a combination of;
a specific pore volume greater than 50% or 60% of the theoretical value;
high angle reflections in powder XRD patterns taken from the material; and
peaks in small angle X-ray scattering (SAXS) data and/or digital diffraction patterns obtained from regions of TEM images;
powder XRD patterns with peak widths indicative of average crystallite sizes in the range of at least 20 nm, or between around 20-40 nm; as fit to the Scherrer equation;
mesopores defined by crystalline rare earth metal oxide material and/or aligned crystallites of rare earth oxide material.

25. A mesoporous rare earth oxide material of any one of claims 21-24, wherein the material is a ceria or doped ceria.

26. The use of a mesoporous rare earth oxide material according to any one of claims 21-25 to catalyse an oxidation process and/or a reduction process.

27. The use according to claim 26, wherein the mesoporous rare earth oxide material is used as a catalyst in a process which comprises both oxidation and reduction of species contacting the catalyst.

28. The use according to claim 26 or 27, as a redox catalyst in an exhaust stream, as a two way catalyst or as a three way catalyst.

29. The use of a mesoporous rare earth oxide material according to any one of claims 21-25 as an electrode, such as a fuel cell electrode and/or an electrolyte material of a fuel cell.

30. The use according to claim 29, in an intermediate temperature solid oxide fuel cell.

31. The use of a mesoporous rare earth oxide material according to any one of claims 21-25 in a photovoltaic device.

32. The use according to claim 31, wherein the mesoporous rare earth oxide material is used as a solid support for a photovoltaic material, such as a photoactive dye.

33. The use according to claim 31 or 32, as a bulk heterojunction.

34. An article comprising a mesoporous rare earth metal oxide material in accordance with any one of claims 21-25.

35. An article according to claim 34, comprising a redox catalyst.

36. An article according to claim 35, wherein the article comprises a cartridge for use in an exhaust stream, such as a vehicle exhaust or a power generator exhaust.

37. An article according to claim 35 or 36, wherein the article is or comprises a catalytic converter for a vehicle.

38. An article according to claim 34 or 35, wherein the article is a fuel cell electrode.

39. An article according to claim 34 or 35, wherein the article is a fuel cell electrolyte structure.

40. An article according to claim 34 or 35, comprising both a fuel cell electrode and an electrolyte structure.

41. An article according to claim 30, wherein the mesoporous rare earth metal oxide material of the electrode and electrolyte structure is of the same or similar composition and/or density.

42. An article according to claim 34 or 35, wherein the article is a fuel cell, in which one or more electrodes or an electrolyte structure comprises a mesoporous rare earth oxide material in accordance with any one of claims 21-25.

43. An article according to claim 34, wherein the article is a photovoltaic device.

44. An article according to claim 43, wherein the photovoltaic device is a bulk heterojunction.

45. An article according to claim 44, wherein the heterojunction comprises a said mesoporous rare earth oxide material impregnated with a photoactive dye.

46. A solar cell, comprising a bulk heterojunction according to claim 45.
